(19) United States
(12) Patent Application Publication
(10) Pub. No.: US 2026/0159680 A1
(43) Pub. Date: Jun. 11, 2026

(54) RESIN COMPOSITION, AND PREPREG, FILM WITH RESIN, METAL FOIL WITH RESIN, METAL-CLAD LAMINATE, AND WIRING BOARD USING SAME

(71) Applicant: Panasonic Intellectual Property Management Co., Ltd., Osaka (JP)

(72) Inventors: Hisashi FUJINAGA, Fukushima (JP); Yuuki HIROKAWA, Fukushima (JP)

(73) Assignee: Panasonic Intellectual Property Management Co., Ltd., Osaka (JP)

(21) Appl. No.: 19/413,758

(22) Filed: Dec. 9, 2025

(30) Foreign Application Priority Data
Dec. 10, 2024 (JP) 2024-215213

(51) Int. Cl. C08L 25/08; B32B 5/26; B32B 15/14; B32B 15/20; C08J 5/24; C08K 3/36; C08K 5/03; C08K 5/3462; C08K 5/5397; C08K 7/16

(52) U.S. Cl. CPC C08L 25/08; B32B 5/26; B32B 15/14; B32B 15/20; C08J 5/244; C08K 3/36; C08K 5/03; C08K 5/3462; C08K 5/5397; C08K 7/16; B32B 2250/40; B32B 2260/023; B32B 2260/046; B32B 2262/101; B32B 2307/204; B32B 2307/30; B32B 2307/304; B32B 2457/04; B32B 2457/08; C08J 2325/08; C08J 2471/12; C08L 2201/02; C08L 2203/20

(57) ABSTRACT

One aspect of the present invention relates to resin composition including: a polyphenylene ether compound (A) having a carbon-carbon unsaturated double bond in a molecule; a polyfunctional vinyl aromatic copolymer (B) containing a repeating unit (bl) derived from a divinyl aromatic compound and a repeating unit (b2) derived from a monovinyl aromatic compound; and a nitrogen-containing compound (C) having at least one among structural units represented by the following formulas (1-1), (1-2), and (1-3).

### FIELD OF INVENTION

The present invention relates to a resin composition and a prepreg, a film with resin, a metal foil with resin, a metal-clad laminate, and a wiring board, which are obtained using the resin composition.

### BACKGROUND ART

In various electronic devices, mounting technologies such as higher integration of semiconductor devices to be mounted, higher wiring density, and multi-layering have rapidly progressed along with an increase in the amount of information processed. A thermosetting resin is generally used as a substrate material for constituting a base material of a wiring board used in various electronic devices, and is required to have high heat resistance (glass transition temperature) in order to respond to multilayering and a high temperature condition in a process such as reflow, and also required to have a low dielectric constant and a low dielectric loss tangent in order to increase a signal transmission speed and reduce a loss during signal transmission.

As such a substrate material, for example, WO 2020/017399 A1 reports a resin composition containing a modified polyphenylene ether compound and an aromatic polymer having a specific structural unit.

On the other hand, base materials for wiring boards of various electronic devices are required to have such properties as adhesiveness in addition to low dielectric properties, but WO 2022/210095 A1 describes that when a nitrogen-containing polymer having a specific repeating structural unit is contained, a composition and a laminate superior in curability, adhesiveness and the like in addition to low dielectric properties can be obtained.

The resin composition containing the modified polyphenylene ether compound and the aromatic polymer described in WO 2020/017399 A1 can afford a cured product or a molded product having low dielectric properties and high heat resistance. On the other hand, curable resin compositions are generally made to contain an inorganic filler for the purpose of improving heat resistance, flame retardancy, and the like in cured products thereof. However, it has been found that a resin composition containing a polyfunctional vinyl aromatic copolymer as described in the document cited above may be poor in adhesion when an inorganic filler is added.

In addition, the resin composition containing a nitrogen-containing polymer described in WO 2022/210095 A1 is superior in adhesiveness, curability, and the like, but has a problem that the dielectric loss tangent (Df) is slightly high and the glass transition temperature (Tg) is also low.

The present invention has been devised in view of such circumstances, and an object of the present invention is to provide a resin composition that maintains adhesion and affords a cured product having low dielectric properties and a high glass transition temperature (Tg).

Another object of the present invention is to provide a prepreg, a film with resin, a metal foil with resin, a metal-clad laminate, and a wiring board, which are obtained using the resin composition.

### SUMMARY OF THE INVENTION

A resin composition according to an aspect of the present invention is characterized by comprising a polyphenylene ether compound (A) having a carbon-carbon unsaturated double bond in a molecule; a polyfunctional vinyl aromatic copolymer (B) containing a repeating unit (bl) derived from a divinyl aromatic compound and a repeating unit (b2) derived from a monovinyl aromatic compound; and a nitrogen-containing compound (C) having at least one among structural units represented by the following formulas (1-1), (1-2), and (1-3).

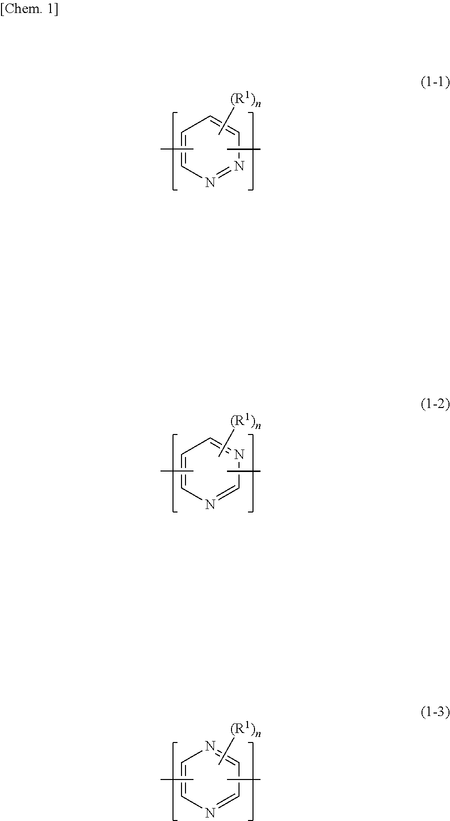

In the formulas (1-1) to (1-3), R¹ is independently at each occurrence a halogen atom, a monovalent hydrocarbon group having 1 to 20 carbon atoms, a monovalent halogenated hydrocarbon group having 1 to 20 carbon atoms, a nitro group, a cyano group, a primary to tertiary amino group, or a salt of a primary to tertiary amino group; n is independently at each occurrence an integer of 0 to 2; when n is 2, the plurality of R¹s may be the same or different and may be bonded in any combination to form a part of a ring structure.

### BRIEF DESCRIPTION OF THE DRAWINGS

FIG. 1 is a schematic sectional view illustrating the configuration of a prepreg according to one embodiment of the present invention;

FIG. 2 is a schematic sectional view illustrating the configuration of a metal-clad laminate according to one embodiment of the present invention;

FIG. 3 is a schematic sectional view illustrating the configuration of a wiring board according to one embodiment of the present invention;

FIG. 4 is a schematic sectional view illustrating the configuration of a metal foil with resin according to one embodiment of the present invention; and

FIG. 5 is a schematic sectional view illustrating the configuration of a film with resin according to one embodiment of the present invention.

### DETAILED DESCRIPTION

### (Resin Composition)

A resin composition according to an embodiment of the present invention (hereinafter also referred to simply as resin composition) includes: a polyphenylene ether compound (A) having a carbon-carbon unsaturated double bond in a molecule; a polyfunctional vinyl aromatic copolymer (B) containing a repeating unit (b1) derived from a divinyl aromatic compound and a repeating unit (b2) derived from a monovinyl aromatic compound; and a nitrogen-containing compound (C). The nitrogen-containing compound (C) has at least one among structural units represented by the following formulas (1-1), (1-2), and (1-3).

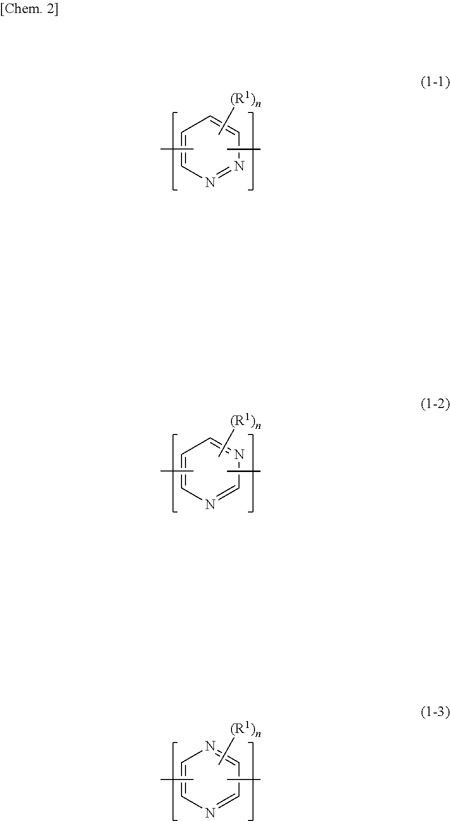

In the formulas (1-1) to (1-3), R¹ is independently at each occurrence a halogen atom, a monovalent hydrocarbon group having 1 to 20 carbon atoms, a monovalent halogenated hydrocarbon group having 1 to 20 carbon atoms, a nitro group, a cyano group, a primary to tertiary amino group, or a salt of a primary to tertiary amino group. n is independently at each occurrence an integer of 0 to 2. When n is 2, the plurality of R¹s may be the same or different and may be bonded in any combination to form a part of a ring structure.

Since the resin composition of the present embodiment contains the polyphenylene ether compound (A) and the polyfunctional vinyl aromatic copolymer (B), a cured product of the resin composition can have excellent low dielectric properties and a high Tg. Furthermore, due to containing the nitrogen-containing compound (C), the resin composition of the present embodiment is also superior in adhesion (particularly, adhesion to copper foil).

That is, according to the present invention, it is possible to provide a resin composition that maintains adhesion and affords a cured product having low dielectric properties and a high glass transition temperature (Tg). By using the resin composition, it is possible to provide a prepreg, a film with resin, a metal foil with resin, a metal-clad laminate, and a wiring board, which are superior in the aforementioned properties.

Hereinafter, the respective components of the resin composition according to the present embodiment will be specifically described.

### <Polyphenylene Ether Compound (A)>

The polyphenylene ether compound that can be used in the present embodiment is not particularly limited as long as it is a polyphenylene ether compound having a carbon-carbon unsaturated double bond in the molecule. Specifically, the polyphenylene ether compound is preferably a polyphenylene ether compound having a functional group containing a carbon-carbon unsaturated double bond. Examples thereof include a polyphenylene ether compound having at least one of groups represented by the following formulas (4) and (5), that is, a modified polyphenylene ether compound in which a molecular terminal is substituted with at least one of groups represented by the following formulas (4) and (5). It is considered that due to containing such a modified polyphenylene ether compound, a resin composition from which a cured product that has low dielectric properties and high heat resistance can be obtained is provided.

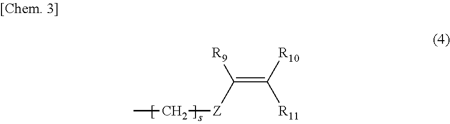

In the formula (4), s represents an integer from 0 to 10. Z represents an arylene group. R₉ to R₁₁ are independent of each other. In other words, R₉ to R₁₁ may be the same group as or different groups from each other. R₉ to R₁₁ represent a hydrogen atom or an alkyl group.

When s is 0 in the formula (4), this indicates that Z is directly bonded to a terminal of polyphenylene ether.

The arylene group represented by Z is not particularly limited. Examples of the arylene group include a monocyclic aromatic group such as a phenylene group, and a polycyclic aromatic group in which the aromatic is not a single ring but a polycyclic aromatic such as a naphthalene ring. The arylene group also includes a derivative in which a hydrogen atom bonded to an aromatic ring is replaced by a functional group such as an alkenyl group, an alkynyl group, a formyl group, an alkylcarbonyl group, an alkenylcarbonyl group, or an alkynylcarbonyl group. In addition, the alkyl group is not particularly limited and is, for example, preferably an alkyl group having 1 to 18 carbon atoms, and more preferably an alkyl group having 1 to 10 carbon atoms. Examples thereof specifically include a methyl group, an ethyl group, a propyl group, a hexyl group, and a decyl group.

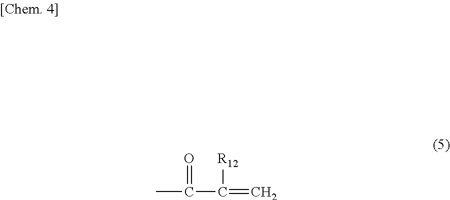

In the formula (5), R₁₂ represents a hydrogen atom or an alkyl group. The alkyl group is not particularly limited and is, for example, preferably an alkyl group having 1 to 18 carbon atoms, and more preferably an alkyl group having 1 to 10 carbon atoms. Examples thereof specifically include a methyl group, an ethyl group, a propyl group, a hexyl group, and a decyl group.

Preferred specific examples of the substituent represented by the formula (4) include a substituent having a vinylbenzyl group. Examples of the substituent having a vinylbenzyl group include a substituent represented by the following formula (6). Examples of the substituent represented by the formula (5) include an acrylate group and a methacrylate group.

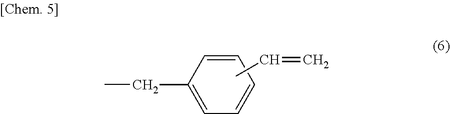

Examples of the substituent more specifically include vinylbenzyl groups (ethenylbenzyl groups) such as a p-ethenylbenzyl group and a m-ethenylbenzyl group, a vinylphenyl group, an acrylate group, and a methacrylate group.

The polyphenylene ether compound (A) has a polyphenylene ether chain in the molecule and preferably has, for example, a repeating unit represented by the following formula (7) in the molecule.

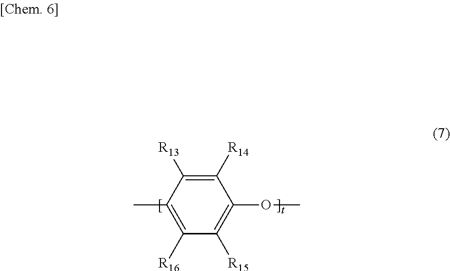

In the formula (7), t represents 1 to 50. R₁₃ to R₁₆ are independent of each other. In other words, R₁₃ to R₁₆ may be the same group as or different groups from each other. R₁₃ to R₁₆ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

Examples of the respective functional groups mentioned in R₁₃ to R₁₆ specifically include the following.

The alkyl group is not particularly limited and is, for example, preferably an alkyl group having 1 to 18 carbon atoms, and more preferably an alkyl group having 1 to 10 carbon atoms. Examples thereof specifically include a methyl group, an ethyl group, a propyl group, a hexyl group, and a decyl group.

The alkenyl group is not particularly limited and is, for example, preferably an alkenyl group having 2 to 18 carbon atoms, and more preferably an alkenyl group having 2 to 10 carbon atoms. Examples thereof specifically include a vinyl group, an allyl group, and a 3-butenyl group.

The alkynyl group is not particularly limited and is, for example, preferably an alkynyl group having 2 to 18 carbon atoms, and more preferably an alkynyl group having 2 to 10 carbon atoms. Examples thereof specifically include an ethynyl group and a prop-2-yn-1-yl group (propargyl group).

The alkylcarbonyl group is not particularly limited as long as it is a carbonyl group substituted with an alkyl group and is, for example, preferably an alkylcarbonyl group having 2 to 18 carbon atoms, and more preferably an alkylcarbonyl group having 2 to 10 carbon atoms. Examples thereof specifically include an acetyl group, a propionyl group, a butyryl group, an isobutyryl group, a pivaloyl group, a hexanoyl group, an octanoyl group, and a cyclohexylcarbonyl group.

The alkenylcarbonyl group is not particularly limited as long as it is a carbonyl group substituted with an alkenyl group and is, for example, preferably an alkenylcarbonyl group having 3 to 18 carbon atoms, and more preferably an alkenylcarbonyl group having 3 to 10 carbon atoms. Examples thereof specifically include an acryloyl group, a methacryloyl group, and a crotonoyl group.

The alkynylcarbonyl group is not particularly limited as long as it is a carbonyl group substituted with an alkynyl group and is, for example, preferably an alkynylcarbonyl group having 3 to 18 carbon atoms, and more preferably an alkynylcarbonyl group having 3 to 10 carbon atoms. Examples thereof specifically include a propioloyl group.

The weight average molecular weight (Mw) of the polyphenylene ether compound (A) is not particularly limited. Specifically, the weight average molecular weight is preferably 500 to 5000, more preferably 800 to 4000, and still more preferably 1000 to 3000. Here, the weight average molecular weight may be any one measured by a general molecular weight measurement method, and examples thereof specifically include a value measured by gel permeation chromatography (GPC). In a case where the polyphenylene ether compound has a repeating unit represented by the formula (7) in the molecule, t is preferably such a numerical value that the weight average molecular weight of the polyphenylene ether compound falls in such a range. Specifically, t is preferably 1 to 50.

When the weight average molecular weight of the polyphenylene ether compound (A) is in such a range, it is considered that the resulting resin composition has superior low dielectric properties inherent in polyphenylene ether, affords a cured product further superior in heat resistance, and is superior in moldability as well. This is considered to be due to the following. With regard to ordinary polyphenylene ether, when the weight average molecular weight thereof is in such a range, since such polyphenylene ether has a relatively low molecular weight, the heat resistance of a cured product tends to decrease. Regarding this point, since the polyphenylene ether compound according to the present embodiment has one or more unsaturated double bonds in the molecule, it is considered that a cured product having sufficiently high heat resistance is obtained. When the weight average molecular weight of the polyphenylene ether compound is within such a range, the polyphenylene ether compound has a relatively low molecular weight and is thus considered to exhibit superior moldability as well. Therefore, such a polyphenylene ether compound is considered to afford a cured product further superior in heat resistance, and to be superior in moldability.

In the polyphenylene ether compound (A), the average number of the substituents (number of terminal functional groups) at the molecular terminal per one molecule of the polyphenylene ether compound is not particularly limited. Specifically, the number of terminal functional groups is preferably 1 to 3, and more preferably 1.5 to 3. When the number of terminal functional groups is excessively small, it tends to be difficult to obtain a cured product having sufficient heat resistance. When the number of terminal functional groups is excessively large, the reactivity is excessively high, and for example, there is a possibility that troubles such as a deterioration in storage stability of the resin composition and a decrease in fluidity of the resin composition may occur. In other words, when such a polyphenylene ether compound is used, for example, molding defects such as generation of voids at the time of multilayer molding occur by insufficient fluidity and the like and a problem of moldability that a highly reliable printed wiring board is hardly obtained may occur. Therefore, the polyphenylene ether compound (A) of the present embodiment preferably includes a polyphenylene ether compound (A-1) having 1 to 3 functional groups described above in the molecule.

The number of the terminal functional groups in the polyphenylene ether compound (A) may be, for example, a numerical value expressing the average value of the substituents per one molecule of all the modified polyphenylene ether compounds present in 1 mol of the polyphenylene ether compound. This number of terminal functional groups can be determined by, for example, measuring the number of hydroxy groups remaining in the resulting modified polyphenylene ether compound and then calculating the decrease from the number of hydroxy groups in the polyphenylene ether before modification. The number of hydroxy groups decreased from the number of hydroxy groups in the polyphenylene ether before modification is the number of terminal functional groups. With regard to the method for measuring the number of hydroxy groups remaining in the modified polyphenylene ether compound, the number of hydroxy groups can be determined by adding a quaternary ammonium salt (tetraethylammonium hydroxide) to be associated with a hydroxy group to a solution of the modified polyphenylene ether compound and measuring the UV absorbance of the mixed solution.

Examples of the polyphenylene ether compound (A) of the present embodiment include a modified polyphenylene ether compound represented by the following formula (8) and a modified polyphenylene ether compound represented by the following formula (9). As the polyphenylene ether compound (A) of the present embodiment, these modified polyphenylene ether compounds may be used singly, or these two modified polyphenylene ether compounds may be used in combination.

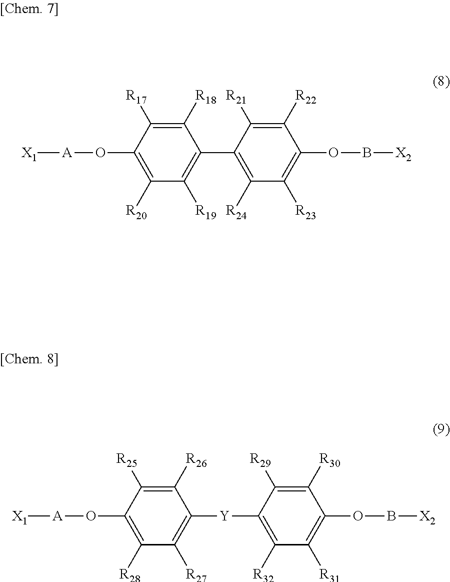

In the formulas (8) and (9), R₁₇ to R₂₄ and R₂₅ to R₃₂ each independently represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable. X₁ and X₂ each independently represent a substituent having a carbon-carbon unsaturated double bond. A and B represent a repeating unit represented by the following formula (10) and a repeating unit represented by the following formula (11), respectively. In the formula (9), Y₁ represents a linear, branched, or cyclic hydrocarbon having 20 or less carbon atoms.

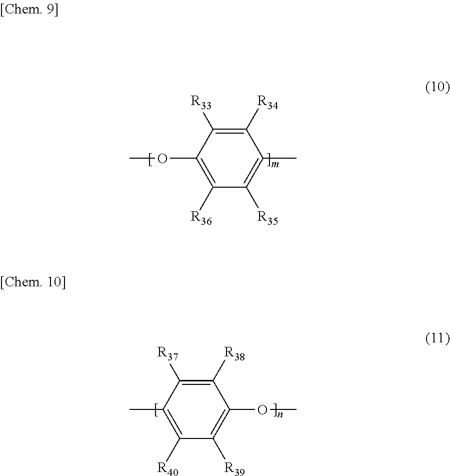

In the formulas (10) and (11), m and n each represent 0 to 20. R₃₃ to R₃₆ and R₃₇ to R₄₀ each independently represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

In the formulas (10) and (11), m and n each preferably represent 0 to 20 as described above. In addition, it is preferable that m and n represent such numerical values that the sum of m and n is 1 to 30. Hence, it is more preferable that m represents 0 to 20, n represents 0 to 20, and the sum of m and n represents 1 to 30.

In the formula (9), Y₁ is a linear, branched, or cyclic hydrocarbon having 20 or less carbon atoms as described above. Examples of Y₁ include a group represented by the following formula (12).

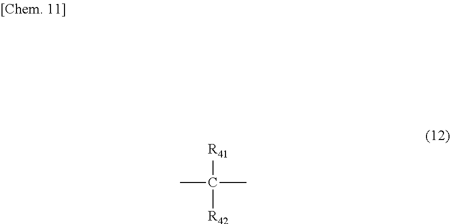

In the formula (12), R₄₁ and R₄₂ each independently represent a hydrogen atom or an alkyl group. Examples of the alkyl group include a methyl group. Examples of the group represented by the formula (12) include a methylene group, a methylmethylene group, and a dimethylmethylene group. Among these, a dimethylmethylene group is preferable.

In the formulas (8) and (9), X₁ and X₂ each independently represent a substituent (functional group) having a carbon-carbon unsaturated double bond. The substituents X₁ and X₂ are not particularly limited as long as they are substituents having a carbon-carbon unsaturated double bond. Examples of the substituents X₁ and X₂ include a substituent represented by the formula (4) and a substituent represented by the formula (5). In the modified polyphenylene ether compound represented by the formula (8) and the modified polyphenylene ether compound represented by the formula (9), X₁ and X₂ may be the same substituent as or different substituents from each other.

More specific examples of the modified polyphenylene ether compound represented by the formula (8) include a modified polyphenylene ether compound represented by the following formula (13).

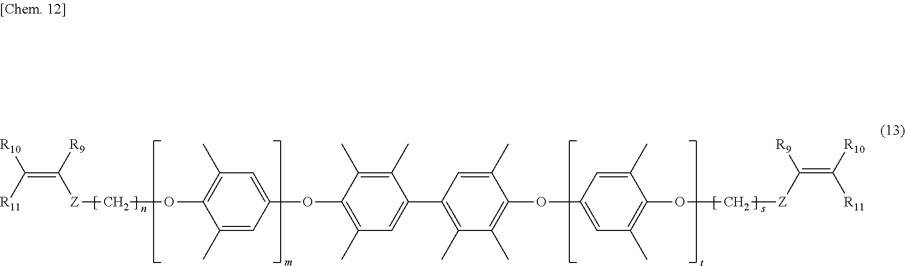

More specific examples of the modified polyphenylene ether compound represented by the formula (9) include a modified polyphenylene ether compound represented by the following formula (14) and a modified polyphenylene ether compound represented by the following formula (15).

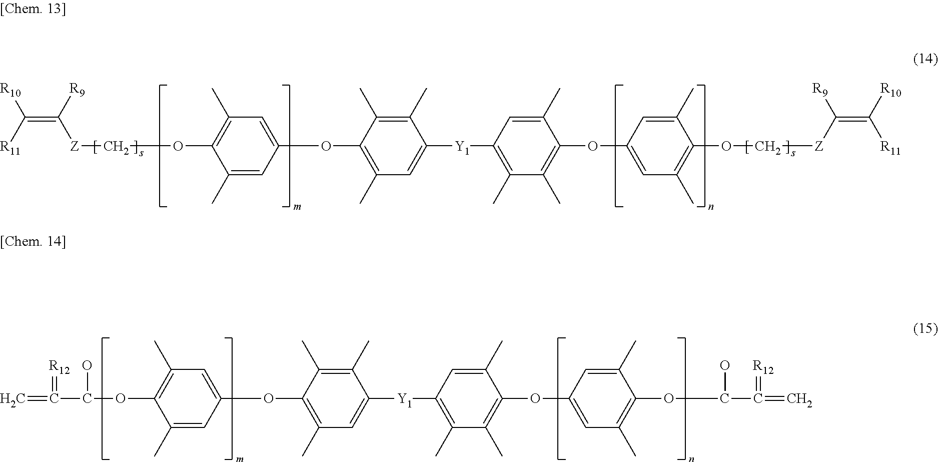

In the formulas (13) to (15), m and n are the same as m and n in the formulas (10) and (11). In the formulas (13) and (14), R₉ to R₁₁, s, and Z are the same as R₉ to R₁₁, s, and Z in the formula (4), respectively. In the formulas (14) and (15), Y₁ is the same as Y₁ in the above (9). In the formula (15), R₁₂ is the same as R₁₂ in the formula (5).

It is considered that by using a modified polyphenylene ether compound as described above, low dielectric properties such as a low dielectric loss tangent, superior heat resistance, and the like can be maintained and adhesion can also be improved.

One kind of the modified polyphenylene ether compounds can be used singly, or two or more kinds thereof can be used in combination.

The polyphenylene ether compound to be used in the resin composition of the present embodiment can be synthesized by a known method, or a commercially available polyphenylene ether compound can be used. Examples of the commercially available product include: “OPE-2st 1200” and “OPE-2st 2200” manufactured by Mitsubishi Gas Chemical Company Inc., and “SA9000” manufactured by SABIC Innovative Plastics.

The content of the polyphenylene ether compound (A) is preferably 5% by mass or more and 40% by mass or less, and more preferably 10% by mass or more and 30% by mass or less with respect to the total amount of the polyphenylene ether compound (A), the polyfunctional vinyl aromatic copolymer (B), and the nitrogen-containing compound (C). Due to containing the polyphenylene ether compound (A) at such a content, the resin composition of the present embodiment affords a cured product that can attain a high Tg and low dielectric properties more reliably.

### <Polyfunctional Vinyl Aromatic Copolymer (B)>

The polyfunctional vinyl aromatic copolymer (B) of the present embodiment is not particularly limited as long as it is a polyfunctional vinyl aromatic copolymer containing a repeating unit (b1) derived from a divinyl aromatic compound. Preferably, the polyfunctional vinyl aromatic copolymer (B) contains a repeating unit (b1) derived from the divinyl aromatic compound and a repeating unit (b2) derived from a monovinyl aromatic compound.

More specifically, for example, the polyfunctional vinyl aromatic polymer (B) to be used in the resin composition of the present embodiment has a repeating unit (b1) derived from a divinyl aromatic compound and a repeating unit (b2) derived from a monovinyl aromatic compound and contains the repeating unit (b1) at 2 mol % or more and less than 95 mol % and the repeating unit (b2) at 5 mol % or more and less than 98 mol % where the sum of the repeating unit (b1) and the repeating unit (b2) is set to 100 mol %.

Preferably, the polyfunctional vinyl aromatic copolymer (B) further contains a repeating unit (b1-1) represented by the following formula (16) as a part of the repeating unit (b1) derived from a divinyl aromatic compound.

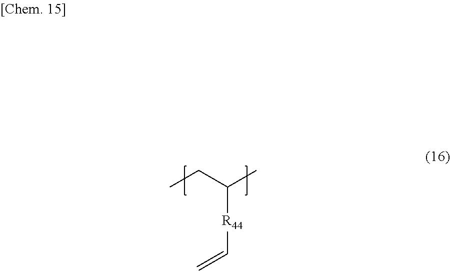

In the formula (16), R₄₄ represents an aromatic hydrocarbon group having 6 to 30 carbon atoms.

Preferable examples of the polyfunctional vinyl aromatic copolymer (B) include a soluble polyfunctional vinyl aromatic copolymer which has a molar fraction of the repeating unit (b1-1) in the total sum of the repeating unit (b1) and the repeating unit (b2) satisfying the following formula (17):

$$0.02 \leq ( b 1 - 1 ) / [ ( b 1 ) + ( b 1 ) ] \leq 0.8 , \qquad ( 17 )$$

a number average molecular weight of 300 to 100,000, a molecular weight distribution represented by the ratio of the weight average molecular weight to the number average molecular weight of 100.0 or less, and is soluble in toluene, xylene, tetrahydrofuran, dichloroethane or chloroform. The soluble polyfunctional vinyl aromatic copolymer is hereinafter also simply referred to as a copolymer.

The soluble polyfunctional vinyl aromatic copolymer contains the repeating unit (b1) at 2 mol % or more and less than 95 mol % and the repeating unit (b2) at 5 mol % or more and less than 98 mol % where the sum of the repeating unit (b1) and the repeating unit (b2) is set to 100 mol %. In addition, the soluble polyfunctional vinyl aromatic copolymer preferably contains the repeating unit (b1-1) at 2 to 80 mol % where the sum of the repeating units (b1) and (b2) is set to 100 mol %.

It is preferable that the number average molecular weight Mn of the soluble polyfunctional vinyl aromatic copolymer is 300 to 100,000 and the molecular weight distribution, which is expressed by the ratio of the weight average molecular weight Mw to the number average molecular weight Mn (Mw/Mn), is 100.0 or less. In addition, the soluble polyfunctional vinyl aromatic copolymer is preferably soluble in toluene, xylene, tetrahydrofuran, dichloroethane, or chloroform.

The soluble polyfunctional vinyl aromatic copolymer is not particularly limited, but examples thereof include a copolymer containing a structural unit derived from a repeating unit (b2) derived from the monovinyl aromatic compound represented by the following formula (18) and a structural unit derived from a repeating unit (b1) derived from the divinyl aromatic compound and the like represented by the following formulas (19) and (20). These structural units may be arranged regularly or randomly.

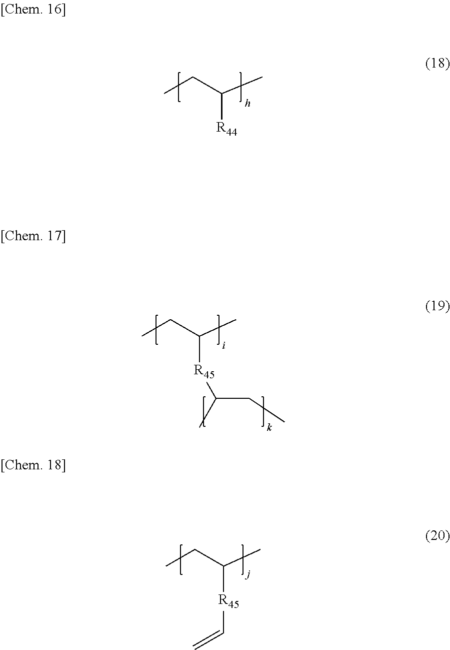

In the formula (18), R₄₄ represents an aromatic hydrocarbon group having 6 to 30 carbon atoms derived from the monovinyl aromatic compound, in the formulas (19) and (20), R₄₅ represents an aromatic hydrocarbon group having 6 to 30 carbon atoms derived from the divinyl aromatic compound, and in the formulas (18) to (20), h to k are each independently an integer of 0 to 200, provided that the sum thereof is 2 to 20,000.

Suitable examples of the soluble polyfunctional vinyl aromatic copolymer include copolymers composed of repeating units in which R₄₄ and R₄₅ in the formulas (18) to (20) are aromatic hydrocarbon groups selected from the group consisting of a phenyl group optionally having a substituent, a biphenyl group optionally having a substituent, a naphthalene group optionally having a substituent, and a terphenyl group optionally having a substituent.

The soluble polyfunctional vinyl aromatic copolymer is preferably soluble in a solvent. The repeating unit as used herein is derived from a monomer, and includes units that are present in the main chain of the copolymer and appear repeatedly and units or terminal groups that are present in the terminals or side chains. A repeating unit is also called a structural unit. The terminal group as used herein includes terminal groups derived from chain transfer reagents described later in addition to those derived from the monomers described above.

The structural unit (b1) derived from a divinyl aromatic compound is contained at 2 mol % or more and less than 95 mol % with respect to the total sum of the structural unit (b1) derived from the divinyl aromatic compound and the structural unit (b2) derived from a monovinyl aromatic compound. The structural unit (b1) derived from a divinyl aromatic compound can have a plurality of structures, such as one in which only one of two vinyl groups has reacted and one in which two of two vinyl groups have reacted, but among these, the repeating unit in which only one vinyl group is reacted and which is represented by the formula (b1-1) is contained preferably at 2 to 80 mol %, more preferably at 5 to 70 mol %, still more preferably at 10 to 60%, and particularly preferably at 15 to 50% with respect to the total sum. It is considered that as a result of setting the repeating unit content to 2 to 80 mol %, the dielectric loss tangent is low, toughness is high, heat resistance is excellent, and compatibility with other resins is excellent. When the repeating unit (b1-1) in which only one vinyl group represented by the formula (16) has reacted is contained at less than 2 mol % with respect to the total sum, the heat resistance tends to decrease, whereas when the repeating unit (b1-1) is contained at more than 80 mol %, the interlayer peel strength of a laminate to be formed tends to decrease.

The soluble polyfunctional vinyl aromatic copolymer contains the structural unit (b2) derived from a monovinyl aromatic compound at 5 mol % or more and less than 98 mol % with respect to the total sum. More preferably, the structural unit (b2) is contained at 10 mol % or more and less than 90 mol %. Still more preferably, the structural unit (b2) is contained at 15 mol % or more and less than 85 mol %. When the content of the structural unit (b2) derived from the monovinyl aromatic compound is less than 5 mol % with respect to the total sum, the molding processability may be insufficient, whereas when the content of the structural unit (b2) exceeds 98 mol %, the heat resistance of a cured product may be insufficient.

The vinyl group present in the formula (16) acts as a crosslinking component and contributes to exertion of the heat resistance of the soluble polyfunctional vinyl aromatic copolymer. Meanwhile, the structural unit (b2) derived from a monovinyl aromatic compound does not have a vinyl group because it is considered that the polymerization usually proceeds through the 1,2-addition reaction of a vinyl group. In other words, the structural unit (b2) derived from a monovinyl aromatic compound does not function as a crosslinking component but contributes to exertion of moldability.

Styrene is preferable as the monovinyl aromatic compound. In addition, a monovinyl aromatic compound other than styrene can be used together with styrene. In this case, the content of the structural unit (b2-1) derived from styrene is preferably 99 to 20 mol % where the total sum of the contents of the structural unit (b2-1) derived from styrene and the structural unit (b2-2) derived from the monovinyl aromatic compound other than styrene is set to 100 mol %. The content of the structural unit (b2-1) is more preferably 98 to 30 mol %. It is preferable that the content of (b2-1) is in the above range because both resistance to thermal oxidation deterioration and moldability are exhibited. When the structural unit (b2-1) is more than 99 mol %, the heat resistance tends to decrease, and when the structural unit (b2-2) is more than 80 mol %, the moldability tends to decrease.

The number average molecular weight (number average molecular weight in terms of standard polystyrene measured using GPC) of the soluble polyfunctional vinyl aromatic copolymer is preferably 300 to 100,000, more preferably 400 to 50,000, and still more preferably 500 to 10,000. When the Mn is less than 300, the amount of the monofunctional copolymer component contained in the soluble polyfunctional vinyl aromatic copolymer increases, so that the heat resistance of the cured product tends to decrease, whereas when the Mn exceeds 100,000, gel is easily generated and the viscosity increases, so that the molding processability tends to decrease.

The value of the molecular weight distribution (Mw/Mn) of the soluble polyfunctional vinyl aromatic copolymer represented by the ratio of the weight average molecular weight (weight average molecular weight in terms of standard polystyrene measured using GPC) to Mn is 100.0 or less, preferably 50.0 or less, more preferably 1.5 to 30.0, and most preferably 2.0 to 20.0. When the Mw/Mn is more than 100.0, the processing properties of the soluble polyfunctional vinyl aromatic copolymer tend to deteriorate, and gel tends to be generated.

The soluble polyfunctional vinyl aromatic copolymer is soluble in toluene, xylene, tetrahydrofuran, dichloroethane, or chloroform as a solvent, and is preferably soluble in any of the solvents. In order for the copolymer to be soluble in solvents and polyfunctional, it is necessary that some of the vinyl groups in divinylbenzene remain uncrosslinked and the copolymer has a proper degree of crosslinking. Here, “soluble in a solvent” means that 5 g or more of the soluble polyfunctional vinyl aromatic copolymer is dissolved in 100 g of the solvent. More preferably, 30 g or more of the copolymer can be dissolved, and particularly preferably, 50 g or more of the copolymer can be dissolved.

The divinyl aromatic compound plays a role in forming a branched structure and making the copolymer polyfunctional as well as plays a role as a crosslinking component for exerting heat resistance when the obtained soluble polyfunctional vinyl aromatic copolymer is heat-cured. Examples of the divinyl aromatic compound are not particularly limited as long as they are aromatic compounds having two vinyl groups, but divinylbenzene (including regioisomers or mixtures thereof), divinylnaphthalene (including regioisomers or mixtures thereof), and divinylbiphenyl (including regioisomers or mixtures thereof) are preferably used. These can be used singly or in combination of two or more kinds thereof. Divinylbenzene (m-isomer, p-isomer, or a regioisomeric mixture thereof) is more preferable from the viewpoint of molding processability.

Examples of the monovinyl aromatic compound include styrene and monovinyl aromatic compounds other than styrene. However, it is desirable to use styrene essentially and a monovinyl aromatic compound other than styrene in combination.

Styrene plays a role in imparting low dielectric properties and resistance to thermal oxidation deterioration to the soluble polyfunctional vinyl aromatic copolymer as a monomer component as well as plays a role in controlling the molecular weight of the soluble polyfunctional vinyl aromatic copolymer as a chain transfer reagent. The monovinyl aromatic compound other than styrene improves the solubility in solvents and the processability of the soluble polyfunctional vinyl aromatic copolymer.

Examples of the monovinyl aromatic compound other than styrene are not particularly limited as long as they are aromatic compounds having one vinyl group other than styrene, and include vinyl aromatic compounds such as vinylnaphthalene and vinylbiphenyl; and nuclear alkyl-substituted vinyl aromatic compounds such as o-methylstyrene, m-methylstyrene, p-methylstyrene, o,p-dimethylstyrene, o-ethylvinylbenzene, m-ethylvinylbenzene and p-ethylvinylbenzene. The monovinyl aromatic compound other than styrene is preferably ethylvinylbenzene (including regioisomers or mixtures thereof), ethylvinylbiphenyl (including regioisomers or mixtures thereof), or ethylvinylnaphthalene (including regioisomers and mixtures thereof) because these prevent gelation of the soluble polyfunctional vinyl aromatic copolymer, are highly effective in improving solubility in solvents and processability, are low in cost, and are readily available. From the viewpoints of dielectric properties and cost, ethylvinylbenzene (m-isomer, p-isomer or a regioisomeric mixture thereof) is more preferable.

Structural units (c) derived from one or two or more other monomer components such as a trivinyl aromatic compound, a trivinyl aliphatic compound, a divinyl aliphatic compound, and a monovinyl aliphatic compound can be introduced into the soluble polyfunctional vinyl aromatic copolymer by using these compounds in addition to the divinyl aromatic compound and the monovinyl aromatic compound as long as the effects of the present invention are not impaired.

Examples of the other monomer components include 1,3,5-trivinylbenzene, 1,3,5-trivinylnaphthalene, 1,2,4-trivinylcyclohexane, ethylene glycol diacrylate, butadiene, 1,4-butanediol divinyl ether, cyclohexanedimethanol divinyl ether, diethylene glycol divinyl ether, and triallyl isocyanurate. These can be used singly or in combination of two or more kinds thereof.

The molar fraction of the other monomer components is preferably less than 30 mol % with respect to the total sum of all monomer components. In other words, the molar fraction of the repeating unit (c) derived from the other monomer components is preferably less than 30 mol % with respect to the total sum of the structural units (b1), (b2), and (c) derived from all the monomer components constituting the copolymer.

The soluble polyfunctional vinyl aromatic copolymer is obtained by polymerizing monomers including the divinyl aromatic compound and the monovinyl aromatic compound in the presence of a Lewis acid catalyst. A known chain transfer reagent (CTR) may also be added during the polymerization for the purpose of controlling the molecular weight.

The content of the polyfunctional vinyl aromatic copolymer (B) is preferably 40% by mass or more and 80% by mass or less, and more preferably 50% by mass or more and 70% by mass or less with respect to the total amount of the polyphenylene ether compound (A), the polyfunctional vinyl aromatic copolymer (B), and the nitrogen-containing compound (C). Due to containing the polyfunctional vinyl aromatic copolymer (B) at such a content, the resin composition of the present embodiment affords a cured product that can attain superior low dielectric properties more reliably.

### <Nitrogen-Containing Compound (C)>

The nitrogen-containing compound (C) to be used in the present embodiment is a nitrogen-containing compound having at least one among structural units represented by the following formulas (1-1), (1-2), and (1-3). Specifically, the nitrogen-containing compound (C) contains a polymer having at least one among structural units represented by the following formulas (1-1), (1-2), and (1-3) (hereinafter also referred to as “specific polymer”).

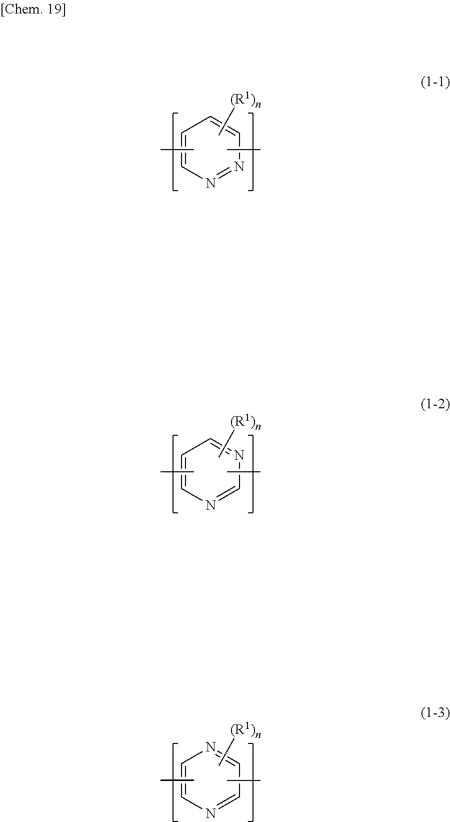

In the formulas (1-1) to (1-3), R¹ is independently at each occurrence a halogen atom, a monovalent hydrocarbon group having 1 to 20 carbon atoms, a monovalent halogenated hydrocarbon group having 1 to 20 carbon atoms, a nitro group, a cyano group, a primary to tertiary amino group, or a salt of a primary to tertiary amino group. n is independently at each occurrence an integer of 0 to 2. When n is 2, the plurality of R¹s may be the same or different and may be bonded in any combination to form a part of a ring structure.

The “hydrocarbon group” as used herein includes a chain hydrocarbon group and a cyclic hydrocarbon group unless otherwise specified. The “hydrocarbon group” may be either a saturated hydrocarbon group or an unsaturated hydrocarbon group. The “chain hydrocarbon group” refers to a hydrocarbon group that does not contain a cyclic structure and is composed only of a chain structure, and includes both a linear hydrocarbon group and a branched hydrocarbon group. The “cyclic hydrocarbon group” refers to a hydrocarbon group containing a cyclic structure, and includes both an alicyclic hydrocarbon group and an aromatic hydrocarbon group. The “alicyclic hydrocarbon group” refers to a hydrocarbon group containing only an alicyclic structure as a cyclic structure and not containing an aromatic ring structure, and includes both a monocyclic alicyclic hydrocarbon group and a polycyclic alicyclic hydrocarbon group. However, the alicyclic hydrocarbon group does not need to be composed of only an alicyclic structure, and may contain a chain structure in a part thereof. The “aromatic hydrocarbon group” refers to a hydrocarbon group containing an aromatic ring structure as a cyclic structure, and includes both a monocyclic aromatic hydrocarbon group and a polycyclic aromatic hydrocarbon group. However, the aromatic hydrocarbon group does not need to be composed of only an aromatic ring structure, and may contain a chain structure or an alicyclic structure in a part thereof. The term “number of ring members” means the number of the atoms constituting a cyclic structure, and in the case of a polycyclic ring, that term means the number of the atoms constituting the polycyclic ring.

Examples of the halogen atom represented by Rⁱ include a fluorine atom, a chlorine atom, a bromine atom, and an iodine atom.

Examples of the monovalent hydrocarbon group having 1 to 20 carbon atoms represented by R¹ include a monovalent chain hydrocarbon group, a monovalent alicyclic hydrocarbon group, and a monovalent aromatic hydrocarbon group.

Examples of the monovalent chain hydrocarbon group include alkyl groups such as a methyl group, an ethyl group, a n-propyl group, an i-propyl group, a n-butyl group, an i-butyl group, a sec-butyl group, a t-butyl group, and a n-pentyl group; alkenyl groups such as an ethenyl group, a propenyl group, a butenyl group, and a pentenyl group; and alkynyl groups such as an ethynyl group, a propynyl group, a butynyl group, and a pentynyl group.

Examples of the monovalent alicyclic hydrocarbon group include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the monovalent aromatic hydrocarbon group include aryl groups such as a phenyl group, a tolyl group, a xylyl group, a naphthyl group, and an anthryl group; and aralkyl groups such as a benzyl group, a phenethyl group, a phenylpropyl group, and a naphthylmethyl group.

Examples of the monovalent halogenated hydrocarbon group having 1 to 20 carbon atoms represented by R¹ include groups in which some or all of the hydrogen atoms of the monovalent hydrocarbon group having 1 to 20 carbon atoms described as an example of the group represented by R¹ are replaced by a halogen atom such as a fluorine atom, a chlorine atom, a bromine atom, or an iodine atom.

Substituents in the secondary amino group and the tertiary amino group represented by R¹ are not particularly limited, and examples thereof include the monovalent hydrocarbon group having 1 to 20 carbon atoms described as an example of the group represented by R¹. The cation constituting the cation moiety in the salt of a primary to tertiary amino group represented by R¹ is not particularly limited, and may be a known cation such as Na⁺.

From the viewpoint of improving the polymerization reactivity and the solubility of the monomer, R¹ is preferably a halogen atom, a monovalent hydrocarbon group having 1 to 6 carbon atoms, a monovalent halogenated hydrocarbon group having 1 to 6 carbon atoms, a nitro group, a cyano group, a primary to tertiary amino group, or a salt of a primary to tertiary amino group, and more preferably a fluorine atom, a chlorine atom, a methyl group, a nitro group, a cyano group, a t-butyl group, a phenyl group, or an amino group. From the same viewpoint, n is preferably 0 or 1, and more preferably 0.

The position of the other bond with respect to one bond of the repeating unit is not particularly limited, but the meta position is preferable in order to improve the polymerization reactivity of the monomer that affords the repeating unit. The repeating unit is preferably a structural unit having a pyrimidine skeleton and represented by the above formula (1-2) from the viewpoint of improving the polymerization reactivity of the monomer and the viewpoint of improving the solubility in various organic solvents.

In a more preferred embodiment, the nitrogen-containing compound (C) of the present embodiment has at least one among structural units represented by the following formulas (2-1), (2-2), and (2-3).

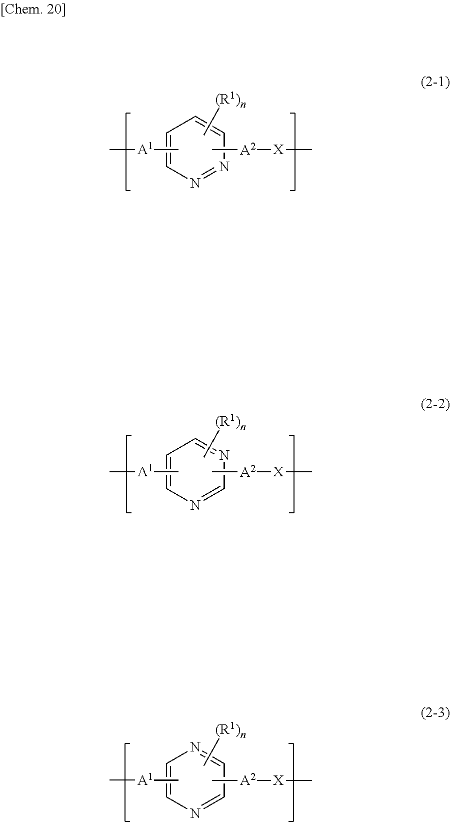

In the formulas (2-1) to (2-3), R¹ and n are the same as R¹ and n in the formulas (1-1) to (1-3). A¹ and A² are each independently —O—, —S—, or —N(R²)—. R² is a hydrogen atom, a monovalent hydrocarbon group having 1 to 20 carbon atoms, or a monovalent halogenated hydrocarbon group having 1 to 20 carbon atoms. X is a divalent organic group.

R² is a hydrogen atom, a monovalent hydrocarbon group having 1 to 20 carbon atoms, or a monovalent halogenated hydrocarbon group having 1 to 20 carbon atoms. Examples of the monovalent hydrocarbon group having 1 to 20 carbon atoms represented by R² include the monovalent hydrocarbon group having 1 to 20 carbon atoms described as an example of the group represented by R¹. In R², some or all of the hydrogen atoms of the hydrocarbon group may be replaced by an ester group or a sulfonyl group.

R² is preferably a hydrogen atom or a monovalent hydrocarbon group having 1 to 10 carbon atoms from the viewpoint of improving the polymerization reactivity of the monomer. When both A¹ and A² are —N(R²)—, the two R²s may be the same or different.

The position of the other bond with respect to one bond of the repeating unit is not particularly limited, but the meta position is preferable in order to improve the polymerization reactivity of the monomer that affords the repeating unit. The repeating unit is preferably a repeating unit having a pyrimidine skeleton and represented by the above general formula (2-2) from the viewpoint of improving the polymerization reactivity of the monomer and the viewpoint of improving the solubility in various organic solvents.

Examples of the monomer that affords such a repeating unit include 4,6-dichloropyrimidine, 4,6-dibromopyrimidine, 2,4-dichloropyrimidine, 2,5-dichloropyrimidine, 2,5-dibromopyrimidine, 5-bromo-2-chloropyrimidine, 5-bromo-2-fluoropyrimidine, 5-bromo-2-iodopyrimidine, 2-chloro-5-fluoropyrimidine, 2-chloro-5-iodopyrimidine, 2,4-dichloro-5-fluoropyrimidine, 2,4-dichloro-5-iodopyrimidine, 5-chloro-2,4,6-trifluoropyrimidine, 2,4,6-trichloropyrimidine, 4,5,6-trichloropyrimidine, 2,4,5-trichloropyrimidine, 2,4,5,6-tetrachloropyrimidine, 2-phenyl-4,6-dichloropyrimidine, 2-methylthio-4,6-dichloropyrimidine, 2-methylsulfonyl-4,6-dichloropyrimidine, 2-amino-4,6-dichloropyrimidine, 5-amino-4,6-dichloropyrimidine, 2,5-diamino-4,6-dichloropyrimidine, 4-amino-2,6-dichloropyrimidine, 4,6-dichloro-5-methoxypyrimidine, 2,4-dichloro-2-methoxypyrimidine, 2,4-dichloro-5-fluoro-pyrimidine, 5-bromo-2,4-dichloropyrimidine, 2,4-dichloro-5-iodopyrimidine, 4,6-dichloro-2-methylpyrimidine, 4,6-dichloro-5-methylpyrimidine, 2,4-dichloro-6-methylpyrimidine, 2,4-dichloro-5-methylpyrimidine, 2,4-dichloro-5-nitropyrimidine, 4-amino-2-chloro-5-fluoropyrimidine, 5-amino-4,6-dichloro-2-methylpyrimidine, 5-bromo-4-chloro-2-methylthiopyrimidine; 3,6-dichloropyridazine, 3,5-dichloropyridazine, 3,6-dichloro-4-methylpyridazine, 2,3-dichloropyrazine, 2,6-dichloropyrazine, 2,5-dibromopyrazine, 2,6-dibromopyrazine, 2-amino-3,5-dibromopyrazine, and 5,6-dicyano-2,3-dichloropyrazine. These monomers may be used singly or in combination of two or more kinds thereof.

A¹ and A² in the above formulas (2-1), (2-2), and (2-3) are each independently —O—, —S—, or —N(R²)—. When A¹ and A² are —O—, this is preferable from the viewpoint of flexibility, solubility, and heat resistance. When A¹ and A² are —N(R²)—, this is preferable from the viewpoint of adhesion and the like. Here, R² is a hydrogen atom or a monovalent hydrocarbon group having 1 to 20 carbon atoms, and may contain an ester group or a sulfonyl group.

The specific polymer preferably contains a group represented by the following formula (3) as the divalent organic group represented by the X in the formulas (2-1), (2-2), and (2-3).

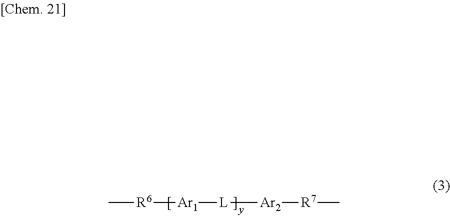

In the formula (3), Ar₁ and Ar₂ are each independently a substituted or unsubstituted aromatic hydrocarbon group. L is a single bond, —O—, —S—, —N(R′), C═O, —SO₂—, P═O, or a divalent organic group. R⁸ is a hydrogen atom, a monovalent hydrocarbon group having 1 to 20 carbon atoms, or a monovalent halogenated hydrocarbon group having 1 to 20 carbon atoms. y is an integer of 0 to 5. When y is 2 or more, the plurality of L's may be the same or different. R⁶ and R⁷ are each independently a single bond, a methylene group, or an alkylene group having 2 to 4 carbon atoms.

The aromatic hydrocarbon groups represented by Ar₁ and Ar₂ are each independently preferably an aromatic hydrocarbon group having 6 or more and 30 or less carbon atoms, more preferably any one among a phenyl group, a naphthyl group, and an anthryl group, and particularly preferably a phenyl group or a naphthyl group.

Each of the aromatic hydrocarbon groups represented by Ar₁ and Ar₂ may have 1 to 8 substituents. The number of the substituents of the aromatic hydrocarbon groups represented by Ar₁ and Ar₂ is preferably 0 to 8, more preferably 0 to 4, and particularly preferably 0 to 2 from the viewpoint of improving the polymerization reactivity of the monomer.

The substituent is not particularly limited, but is a halogen atom, a monovalent hydrocarbon group having 1 to 20 carbon atoms, a monovalent halogenated hydrocarbon group having 1 to 20 carbon atoms, an alkoxy group having 1 to 20 carbon atoms, an alkylthio group having 1 to 20 carbon atoms, a nitro group, a cyano group, a carboxy group, a sulfonic acid group, a phosphonic acid group, a phosphoric acid group, a hydroxy group, a primary to tertiary amino group, a salt of a carboxy group, a salt of a sulfonic acid group, a salt of a phosphonic acid group, a salt of a phosphoric acid group, a salt of a hydroxy group, or a salt of a primary to tertiary amino group.

Examples of the halogen atom include a fluorine atom, a chlorine atom, a bromine atom, and an iodine atom.

Examples of the monovalent hydrocarbon group having 1 to 20 carbon atoms include the monovalent hydrocarbon groups having 1 to 20 carbon atoms described as examples of the group represented by R¹ in the formulas (1-1) to (1-3).

Examples of the monovalent halogenated hydrocarbon group having 1 to 20 carbon atoms include groups in which some or all of the hydrogen atoms of the monovalent hydrocarbon group having 1 to 20 carbon atoms described as an example of the group represented by R¹ in the formulas (1-1) to (1-3) are replaced by a halogen atom such as a fluorine atom, a chlorine atom, a bromine atom, or an iodine atom.

Examples of the alkoxy group having 1 to 20 carbon atoms include a methoxy group, an ethoxy group, a n-propoxy group, an isopropoxy group, a butoxy group, a pentyloxy group, a hexyloxy group, and an octyloxy group.

Examples of the alkylthio group having 1 to 20 carbon atoms include a methylthio group, an ethylthio group, a n-propylthio group, an isopropylthio group, a butylthio group, a pentylthio group, a hexylthio group, and an octylthio group.

The substituent in the secondary amino group and the tertiary amino group is not particularly limited, and examples thereof include the monovalent hydrocarbon group having 1 to 20 carbon atoms described as an example of the group represented by R¹.

The cation constituting the cation moiety in the salt of a carboxy group, the salt of a sulfonic acid group, the salt of a phosphonic acid group, the salt of a phosphoric acid group, the salt of a hydroxy group, and the salt of a primary to tertiary amino group is not particularly limited, and may be a known cation such as Na⁺.

As the substituent of the aromatic hydrocarbon group represented by Ar₁ and Ar₂, a halogen atom, a monovalent hydrocarbon group having 1 to 3 carbon atoms, a monovalent halogenated hydrocarbon group having 1 to 3 carbon atoms, an alkoxy group having 1 to 3 carbon atoms, an alkylthio group having 1 to 3 carbon atoms, a nitro group, a cyano group, a carboxy group, a sulfonic acid group, a phosphonic acid group, a phosphoric acid group, a hydroxy group, a primary to tertiary amino group, a salt of a carboxy group, a salt of a sulfonic acid group, a salt of a phosphonic acid group, a salt of a phosphoric acid group, a salt of a hydroxy group, or a salt of a primary to tertiary amino group is preferable from the viewpoint of improving the polymerization reactivity of the monomer, and a fluorine atom, a chlorine atom, a methyl group, an ethyl group, a fluoromethyl group, a methoxy group, a methylthio group, a nitro group, a cyano group, a carboxy group, a sulfonic acid group, a phosphonic acid group, a phosphoric acid group, a hydroxy group, a primary to tertiary amino group, a salt of a carboxy group, a salt of a sulfonic acid group, a salt of a phosphonic acid group, a salt of a phosphoric acid group, a salt of a hydroxy group, or a salt of a primary to tertiary amino group is more preferable. From the same viewpoint, a and b are each preferably 0 to 8, more preferably 0 to 4, and particularly preferably 0 to 2. Furthermore, from the same viewpoint, c and d are each preferably 0 to 2, and more preferably 0 or 1.

Examples of the divalent organic group having 1 to 20 carbon atoms represented by L include a methylene group, an alkylene group having 2 to 20 carbon atoms, a halogenated methylene group, a halogenated alkylene group having 2 to 20 carbon atoms, and a divalent cardo structure.

Examples of the alkylene group having 2 to 20 carbon atoms represented by L include an ethylene group, a n-propylene group, an isopropylene group, a n-butylene group, a sec-butylene group, a tert-butylene group, a neopentylene group, a 4-methyl-pentane-2-diyl group, and a nonane-1,9-diyl group.

Examples of the halogenated methylene group represented by L include groups in which some or all of the hydrogen atoms of the methylene group are replaced by a halogen atom such as a fluorine atom, a chlorine atom, a bromine atom, or an iodine atom.

Examples of the halogenated alkylene group having 2 to 20 carbon atoms represented by L include groups in which some or all of the hydrogen atoms of the alkylene group having 2 to 20 carbon atoms described as an example of the group represented by L are replaced by a halogen atom such as a fluorine atom, a chlorine atom, a bromine atom, or an iodine atom.

Examples of the divalent cardo structure represented by L include a divalent group derived from fluorene (namely, a group formed by removing two hydrogen atoms in fluorene), a divalent group derived from phenolphthalein (namely, a group formed by removing two hydrogen atoms in phenolphthalein), and a group represented by the following formula (L1). In the divalent group derived from fluorene and the divalent group derived from phenolphthalein, some or all of hydrogen atoms may be replaced by a monovalent chain hydrocarbon group having 1 to 20 carbon atoms, and further, some or all of hydrogen atoms including the substituent may be replaced by a fluorine atom.

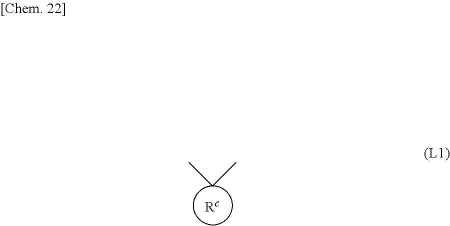

In the formula (L1), R^{o} represents a divalent alicyclic hydrocarbon group having the number of ring members of 5 to 30.

Examples of the divalent alicyclic hydrocarbon group having the number of ring members of 5 to 30 represented by R^{c} include a monocyclic alicyclic hydrocarbon group having the number of ring members of 5 to 15, a monocyclic fluorinated alicyclic hydrocarbon group having the number of ring members of 5 to 15, a polycyclic alicyclic hydrocarbon group having the number of ring members of 7 to 30, and a polycyclic fluorinated alicyclic hydrocarbon group having the number of ring members of 7 to 30.

Examples of the monocyclic alicyclic hydrocarbon group having the number of ring members of 5 to 15 include a cyclopentane-1,1-diyl group, a cyclohexane-1,1-diyl group, a 3,3,5-trimethylcyclohexane-1,1-diyl group, a cyclopentene-3,3-diyl group, a cyclohexene-3,3-diyl group, a cyclooctane-1,1-diyl group, a cyclodecane-1,1-diyl group, a cyclododecane-1,1-diyl group, and groups in which some or all of the hydrogen atoms of these groups are replaced by a monovalent chain hydrocarbon group having 1 to 20 carbon atoms, or the like.

Examples of the monocyclic fluorinated alicyclic hydrocarbon group having the number of ring members of 5 to 15 include groups in which some or all of the hydrogen atoms of the groups described as examples of the monocyclic alicyclic hydrocarbon group having the number of ring members of 5 to 15 are replaced by a fluorine atom.

Examples of the polycyclic alicyclic hydrocarbon group having the number of ring members of 7 to 30 include groups formed by removing two hydrogen atoms bonded to one carbon atom of a polycyclic alicyclic hydrocarbon such as norbornane, norbornene, adamantane, tricyclo[5.2.1.0^{2,6}]decane, tricyclo[5.2.1.0^{2,6}]heptane, pinane, camphane, decalin, nortricyclane, perhydroanthracene, perhydroazulene, cyclopentanohydrophenanthrene, and bicyclo[2.2.2]-2-octene, and groups in which some or all of the hydrogen atoms of those groups are replaced by a monovalent chain hydrocarbon group having 1 to 20 carbon atoms.

Examples of the polycyclic fluorinated alicyclic hydrocarbon group having the number of ring members of 7 to 30 include groups in which some or all of the hydrogen atoms of the groups described as examples of the polycyclic alicyclic hydrocarbon group having the number of ring members of 7 to 30 are replaced by a fluorine atom.

L is preferably a single bond, —O—, —S—, —C(O)—, —S(O)—, —S(O)₂—, —C(O)—NH—, —C(O)—O—, a methylene group, an alkylene group having 2 to 5 carbon atoms, a halogenated methylene group, a halogenated alkylene group having 2 to 10 carbon atoms, or a divalent cardo structure from the viewpoint of the structural stability of the polymer. From the same viewpoint, y is preferably 0 to 4, and more preferably 0 to 3.

Examples of the alkylene group having 2 to 4 carbon atoms represented by R⁶ and R⁷ in the formula (3) include an ethylene group, a n-propylene group, an isopropylene group, a n-butylene group, a sec-butylene group, and a tert-butylene group. R⁶ and R⁷ are each preferably a single bond, a methylene group, or an ethylene group from the viewpoint of improving the polymerization reactivity of the monomer.

y is an integer of 0 to 5. From the viewpoint of improving the solubility of the polymer and imparting flexibility, y is preferably 1 or more. In addition, when y is 2 or more, the plurality of L's may be the same or different.

The content ratio of the repeating units represented by the formulas (2-1), (2-2) and (2-3) in the specific polymer is preferably 1 to 95 mol %, and more preferably 5 to 80 mol % where the total of all repeating units in the specific polymer is 100 mol %.

The method for synthesizing the specific polymer is not particularly limited, and a known method can be used. For example, the specific polymer can be synthesized by heating a monomer that affords at least one repeating unit among the repeating units represented by the above formulas (2-1), (2-2) and (2-3) and, as necessary, other monomers together with an alkali metal or the like in an organic solvent.

The lower limit of the weight average molecular weight (Mw) of the specific polymer is preferably 500, more preferably 1,000, still more preferably 2,000, and particularly preferably 3,000. The upper limit of the weight average molecular weight (Mw) is preferably 600,000, more preferably 300,000, and particularly preferably 200,000.

The lower limit of the glass transition temperature (Tg) of the specific polymer is preferably 70° C., and more preferably 80° C. The upper limit of the glass transition temperature (Tg) is preferably 320° C. and more preferably 300° C. from the viewpoint of processability.

The nitrogen-containing compound (C) of the present embodiment preferably has a group Y represented by the following formula (a) at a terminal.

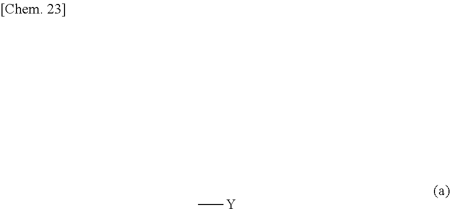

In the formula (a), Y is a group having 3 to 50 carbon atoms and containing an ethylenically unsaturated double bond, an unsubstituted or substituted aromatic hydrocarbon group having 6 to 50 carbon atoms, an unsubstituted or substituted aliphatic hydrocarbon group having 6 to 50 carbon atoms, or an unsubstituted nitrogen-containing heteroaromatic ring; when the aromatic hydrocarbon group or the aliphatic hydrocarbon group has a substituent, the substituent is a group other than a hydroxy group.

The terminal group Y is bonded to a main chain terminal of the nitrogen-containing compound (C) to form a terminal portion of the nitrogen-containing compound (C). That is, the terminal group Y is a group different from R¹ and A¹ in the formulas (1-1) to (1-3) and the formulas (2-1) to (2-3) and the groups constituting the terminals in X (for example, R⁶ and R⁷ in the formula (3)).

The terminal group Y is preferably an aromatic or aliphatic hydrocarbon group having small polarization or a nitrogen-containing heteroaromatic ring in order to improve dielectric properties, and when the terminal group Y further contains an ethylenically unsaturated double bond, the crosslinking density can be improved, and therefore heat resistance and curability can be expected.

Examples of the group having 3 to 50 carbon atoms and containing an ethylenically unsaturated double bond include aromatic ring-containing groups such as a 3-isopropenylphenyl group, a 4-isopropenylphenyl group, a 2-allylphenyl group, a 2-methoxy-4-allylphenyl group, a 4-(1-propenyl)-2-methoxyphenyl group, a 4-vinylbenzyl group, a 3-vinylbenzyl group, and a 2-vinylbenzyl group, an allyl group, an acrylic group, a methacrylic group, and a methallyl group.

Examples of the aromatic hydrocarbon group having 6 to 50 carbon atoms include aryl groups such as a phenyl group, a biphenyl group, a tolyl group, a xylyl group, a naphthyl group, and an anthryl group; and aralkyl groups such as a benzyl group, a phenethyl group, a phenylpropyl group, and a naphthylmethyl group.

Examples of the aliphatic hydrocarbon group having 6 to 50 carbon atoms include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the nitrogen-containing heteroaromatic ring in the unsubstituted nitrogen-containing heteroaromatic ring include a pyrrole ring, a pyridine ring, a pyrimidine ring, a pyrazine ring, a pyridazine ring, a triazine ring, a quinoline ring, an isoquinoline ring, a quinoxaline ring, a phthalazine ring, a quinazoline ring, a naphthyridine ring, a carbazole ring, an acridine ring, and a phenazine ring. As the nitrogen-containing heteroaromatic ring, a pyrimidine ring is preferable from the viewpoint that the polymer (A) can be synthesized with good polymerization reactivity, and the polymer (A) superior in solubility in various organic solvents can be easily obtained.

The substituent in the unsubstituted or substituted aromatic hydrocarbon group having 6 to 50 carbon atoms, the unsubstituted or substituted aliphatic hydrocarbon group having 6 to 50 carbon atoms, and the unsubstituted nitrogen-containing heteroaromatic ring is a group other than a hydroxy group, and examples thereof include an allyl group, a halogen atom, a monovalent hydrocarbon group having 1 to 20 carbon atoms, a monovalent halogenated hydrocarbon group having 1 to 20 carbon atoms, an alkoxy group having 1 to 20 carbon atoms, an alkylthio group having 1 to 20 carbon atoms, a nitro group, a cyano group, a carboxy group, a sulfonic acid group, a phosphonic acid group, a phosphoric acid group, a primary to tertiary amino group, a salt of a carboxy group, a salt of a sulfonic acid group, a salt of a phosphonic acid group, a salt of a phosphoric acid group, and a salt of a primary to tertiary amino group. Among them, an allyl group is preferable.

A nitrogen-containing compound (C) having a terminal sealed with the terminal group Y can be obtained by conducting a reaction using at least one monomer for forming the terminal group Y selected from the group consisting of a monovalent phenol, a monovalent amine, a monovalent thiol, a monovalent aromatic compound, a monovalent aliphatic halide, a monovalent acid halide, and a monovalent acid anhydride as a raw material in addition to the monomer that affords R¹ in the formulas (1-1) to (1-3) or the formulas (2-1) to (2-3).

In the case of synthesizing a nitrogen-containing compound (C) in which the terminal group Y contains a double bond, for example, in order to avoid that the double bonds in the monomer for forming the terminal group Y react with each other at the time of polymerization of the monomer as a raw material of the main chain and gelate, the monomer for forming the terminal group Y may be added and reacted after the polymerization of the monomer as a raw material of the main chain.

Examples of the monomer for forming the terminal group Y include monovalent phenol compounds such as t-butylphenol, nonylphenol, 4-isopropenylphenol, 4-vinylphenol, 2-allylphenol, isoeugenol, tocotrienol, α-tocopherol, 4-hydroxyphenylmaleimide, and 2-phenylphenol; monovalent amine compounds such as 4-hexylaniline and diallylamine; monovalent thiol compounds such as 1-octanethiol; monovalent aliphatic halides such as allyl chloride, 4-(chloromethyl)styrene, and 3-(chloromethyl)styrene; monovalent acid halides such as acrylic chloride, methacrylic chloride, crotonoyl chloride, and cinnamoyl chloride; and monovalent acid anhydrides such as acrylic anhydride, crotonic anhydride, and methacrylic anhydride. These monomers may be used singly, or two or more kinds thereof may be used.

The nitrogen-containing compound (C) can be synthesized, but a commercially available product may be used. For example, “HC-G 0037” manufactured by JSR Corporation can be used.

The content of the nitrogen-containing compound (C) is preferably 5% by mass or more and 50% by mass or less, and more preferably 10% by mass or more and 30% by mass or less with respect to the total amount of the polyphenylene ether compound (A), the polyfunctional vinyl aromatic copolymer (B), and the nitrogen-containing compound (C). Due to containing the nitrogen-containing compound (C) in such a content, the resin composition of the present embodiment affords a cured product that can attain superior adhesion more reliably.

### <Inorganic Filler (D)>

The resin composition of the present embodiment may include an inorganic filler (D), as necessary, as long as the effects of the present invention are not impaired. Accordingly, it is considered that the low thermal expansion property and the like of the cured product of the resin composition can be enhanced. Examples of the inorganic filler that can be used in the present embodiment specifically include a filler made of a material composed of at least one selected from the group consisting of metal oxides such as silica, alumina, titanium oxide, magnesium oxide, and mica, metal hydroxides such as magnesium hydroxide and aluminum hydroxide, talc, aluminum borate, barium sulfate, aluminum nitride, boron nitride, barium titanate, strontium titanate, calcium titanate, aluminum titanate, barium zirconate titanate, barium zirconate, calcium zirconate, zirconium phosphate, zirconium tungstate phosphate, magnesium carbonate such as anhydrous magnesium carbonate, calcium carbonate, and boehmite-treated products thereof. Among these materials, silica, metal hydroxides such as magnesium hydroxide and aluminum hydroxide, aluminum oxide, boron nitride, and barium titanate, strontium titanate and the like are preferable, and silica is more preferable. The silica is not particularly limited, and examples thereof include crushed silica, spherical silica, and silica particles.

These inorganic fillers may be used singly or in combination of two or more kinds thereof. An inorganic filler as described above may be used as it is, but one subjected to a surface treatment with an epoxysilane-type, vinylsilane-type, methacrylsilane-type, phenylaminosilane-type, or aminosilane-type silane coupling agent may be used. The silane coupling agent can be used by being added to the filler by an integral blend method instead of the method of treating the surface of the filler with the silane coupling agent in advance.

In a case where the resin composition of the present embodiment contains the inorganic filler (D), the content thereof is preferably 30 parts by mass or more and 150 parts by mass or less, and more preferably 40 parts by mass and 140 parts by mass or less with respect to 100 parts by mass of the sum of the polyphenylene ether compound (A), the polyfunctional vinyl aromatic copolymer (B), and the nitrogen-containing compound (C).

### <Flame Retardant (E)>

The resin composition of the present embodiment preferably includes a flame retardant (E). The flame retardancy of a cured product of the resin composition can be further enhanced by containing the flame retardant.

The flame retardant that can be used in the present embodiment is not particularly limited. Specifically, a flame retardant containing phosphorus (phosphorus-based flame retardant) is suitably used in fields required to be halogen-free. The phosphorus-based flame retardant is not particularly limited, and examples thereof include an HCA-based flame retardant, a phosphate ester-based flame retardant, a phosphazene-based flame retardant, a bis(diphenylphosphine oxide)-based flame retardant, and a phosphinate-based flame retardant. Examples of the HCA-based flame retardant include 9,10-dihydro-9-oxa-10-phosphaphenanthren-10-yl-10-oxide, 10-(2,5-dihydroxyphenyl)-9,10-dihydro-9-oxa-10-phosphaphenanthrene-10-oxide, and compounds obtained by reacting these in advance. Examples of the phosphate ester-based flame retardant include a condensed phosphate ester such as dixylenyl phosphate. Examples of the phosphazene-based flame retardant include phenoxyphosphazene. Examples of the bis(diphenylphosphine oxide)-based flame retardant include xylylene bis(diphenylphosphine oxide). Examples of the phosphinate-based flame retardant include metal phosphinates such as an aluminum dialkyl phosphinate.

In the field in which halogen-based flame retardants such as bromine-based flame retardants are used, for example, ethylene dipentabromobenzene, ethylene bistetrabromoimide, decabromodiphenyl oxide, and tetradecabromodiphenoxybenzene, which have a melting point of 300° C. or more, are preferable. It is considered that the elimination of halogen at a high temperature and the decrease in heat resistance can be suppressed by the use of a halogen-based flame retardant.

As the flame retardant (E), the flame retardants described as examples may be used singly or in combination of two or more kinds thereof.

### <Other Thermally Curable Compounds>

The resin composition of the present embodiment may further include a thermally curable compound other than the polyphenylene ether compound (A) and the polyfunctional vinyl aromatic copolymer (B) as long as the effects of the present invention are not impaired.

Examples of the thermally curable compound include acenaphthylene compounds, and polyfunctional hydrocarbon-based compounds having a carbon-carbon unsaturated group other than the polyfunctional vinyl aromatic copolymer (B). These can be used singly or in combination of two or more kinds thereof.

### <Other Components>

The resin composition according to the present embodiment may contain components other than the components described above (other components) as necessary as long as the effects of the present invention are not impaired. Examples of the other components contained in the resin composition according to the present embodiment include additives such as catalysts including a reaction initiator and a reaction accelerator, a polymerization inhibitor, a reaction retardant, a free radical compound, an auxiliary flame retardant, an antifoaming agent, a leveling agent, an antioxidant, a heat stabilizer, an antistatic agent, an ultraviolet absorber, a dye or a pigment, a dispersant, and a lubricant.

The resin composition according to the present embodiment may contain a reaction initiator (catalyst) or a reaction accelerator as described above. The radical polymerization (curing) reaction of the resin composition can proceed even without a reaction initiator. However, a reaction initiator may be added because there is a case where it is difficult to raise the temperature until curing proceeds depending on the process conditions. The reaction initiator and reaction accelerator are not particularly limited as long as they can promote the curing reaction of the resin composition. Specifically, examples thereof include azo compounds, peroxides, metal oxides, imidazole compounds, phosphorus-based curing accelerators, and amine-based curing accelerators.

Examples of the azo compounds include organic azo compounds such as azobisisobutyronitrile, 2,2′-azobis(2,4,4-trimethylpentane), 2,2′-azobis(N-butyl-2-methylpropionamide), and 2,2′-azobis(2-methylbutyronitrile). Examples of the organic peroxides include α,α′-di(t-butylperoxy)diisopropylbenzene (PBP), 2,5-dimethyl-2,5-di(t-butylperoxy)-3-hexyne, benzoyl peroxide, 3,3′,5,5′-tetramethyl-1,4-diphenoquinone, chloranil, 2,4,6-tri-t-butylphenoxyl, and t-butylperoxyisopropyl monocarbonate.

When the resin composition of the present embodiment contains the reaction initiator, the content thereof is not particularly limited, but for example, the content is preferably about 0.1 to about 5.0 parts by mass with respect to 100 parts by mass of the sum of the resin components.

As described above, the resin composition according to the present embodiment may contain a free radical compound, as necessary. It is considered that by containing the free radical compound, the resin composition of the present embodiment can further improve moldability while maintaining cured product properties such as Tg. The free radical compound is a compound having a free radical group in the molecule, and is a compound different from the polyphenylene ether compound (A), the polyfunctional vinyl aromatic copolymer (B), and the nitrogen-containing compound (C). The free radical compound can exhibit the effect of delaying the radical reaction and moderating the curing reaction of the resin composition by supplementing radicals by free radical groups in the molecule. Examples of the free radical compound include a free radical compound having a 2,2,6,6-tetramethylpiperidine-1-oxyl (TEMPO) structure in the molecule. As the free radical compound, a commercially available product may be used, and examples of the commercially available product of the free radical compound include LA-7RD manufactured by ADEKA Corporation.

In the case where the free radical compound is contained, the content thereof is preferably 0.001 to 0.1 parts by mass, and more preferably 0.001 to 0.05 parts by mass with respect to 100 parts by mass of the sum of the resin components.

(Prepreg, Film with Resin, Metal-Clad Laminate, Wiring Board, and Metal Foil with Resin)

Next, a prepreg for wiring board, a metal-clad laminate, a wiring board, and a metal foil with resin obtained using the resin composition of the present embodiment will be described. In the following description, the reference numerals denote: 1 prepreg, 2 resin composition or semi-cured product of resin composition, 3 fibrous base material, 11 metal-clad laminate, 12 insulating layer, 13 metal foil, 14 wiring, 21 wiring board, 31 metal foil with resin, 32 and 42 resin layer, 41 film with resin, and 43 support film, respectively.

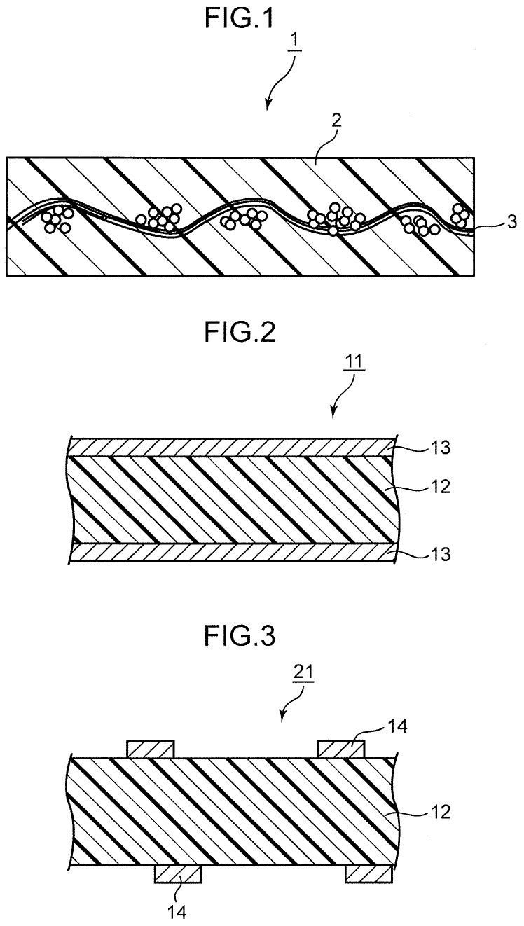

FIG. 1 is a schematic sectional view illustrating an example of a prepreg 1 according to one embodiment of the present invention.

As illustrated in FIG. 1, the prepreg 1 according to the present embodiment includes the resin composition or a semi-cured product of the resin composition 2 and a fibrous base material 3. Examples of the prepreg 1 include those in which the fibrous base material 3 is present in the resin composition or a semi-cured product thereof 2. In other words, the prepreg 1 includes the resin composition or a semi-cured product thereof, and the fibrous base material 3 present in the resin composition or a semi-cured product thereof 2.

In the present embodiment, the “semi-cured product” is one in a state in which the resin composition has been partially cured to such an extent that the resin composition can be further cured. That is, the semi-cured product is a resin composition brought into a semi-cured state (B-staged). For example, when a resin composition is heated, the viscosity of the resin composition first gradually decreases, then curing starts, and the viscosity gradually increases. In such a case, semi-curing includes a state between after the viscosity starts to increase and before the resin composition is completely cured, and the like.

The prepreg obtained using the resin composition according to the present embodiment may include a semi-cured product of the resin composition as described above, or may include the uncured resin composition itself. In other words, the prepreg may be a prepreg including a semi-cured product of the resin composition (the resin composition in B stage) and a fibrous base material, or may be a prepreg including the resin composition before curing (the resin composition in A stage) and a fibrous base material. Examples of the prepreg specifically include those in which a fibrous base material is present in the resin composition. The resin composition or a semi-cured product thereof may be one obtained by heating and drying the resin composition.

When the prepreg and the metal foil with resin, metal-clad laminate and the like to be described later are fabricated, the resin composition according to the present embodiment is often prepared in the form of a varnish and used as a resin varnish. Such a resin varnish is prepared, for example, as follows.

First, the respective components that can be dissolved in an organic solvent, such as a resin component and a reaction initiator, are put into an organic solvent and dissolved. At this time, heating may be performed, as necessary. Thereafter, an inorganic filler and the like, which are components that do not dissolve in an organic solvent, are added to and dispersed in the solution until a predetermined dispersion state is achieved using a ball mill, a bead mill, a planetary mixer, a roll mill or the like, whereby a varnish-like resin composition is prepared. The organic solvent used here is not particularly limited as long as it dissolves resin components such as the polyphenylene ether compound (A), the polyfunctional vinyl aromatic copolymer (B), and the nitrogen-containing compound (C) and does not inhibit the curing reaction. Examples thereof specifically include toluene, methyl ethyl ketone, cyclohexanone, cyclopentanone, methylcyclohexane, dimethylformamide, and propylene glycol monomethyl ether acetate. These may be used singly, or two or more kinds thereof may be used in combination.

Examples of the method for fabricating the prepreg 1 of the present embodiment using the varnish-like resin composition of the present embodiment include a method in which the fibrous base material 3 is impregnated with the resin composition 2 in the form of a resin varnish and then drying is performed.

Examples of the fibrous base material to be used in the fabrication of the prepreg specifically include glass cloth, aramid cloth, polyester cloth, LCP (liquid crystal polymer) nonwoven fabric, glass nonwoven fabric, aramid nonwoven fabric, polyester nonwoven fabric, pulp paper, and linter paper. When glass cloth is used, a laminate superior in mechanical strength is obtained, and glass cloth subjected to flattening is particularly preferable. The glass cloth to be used in the present embodiment is not particularly limited, but examples thereof include glass cloth with low dielectric constant such as E glass, S glass, NE glass, Q glass, and L glass. Specifically, the flattening can be conducted, for example, by continuously pressing the glass cloth with press rolls at an appropriate pressure to flatten the yarn. As for the thickness of the fibrous base material, for example, a fibrous base material having a thickness of 0.01 to 0.3 mm can be generally used.

The impregnation of the fibrous base material 3 with the resin varnish (resin composition 2) is performed by dipping, coating, or the like. This impregnation can be repeated multiple times, as necessary. At this time, it is also possible to repeat impregnation using a plurality of resin varnishes having different compositions or concentrations, and adjust the composition (content ratio) and resin amount to the finally desired values.

The fibrous base material 3 impregnated with the resin varnish (resin composition 2) is heated under desired heating conditions, for example, at 80° C. or more and 180° C. or less for 1 minute or more and 10 minutes or less. By heating, the solvent is volatilized from the varnish, and the solvent is thereby diminished or removed, whereby the prepreg 1 before curing (in A stage) or in a semi-cured state (B stage) is obtained.

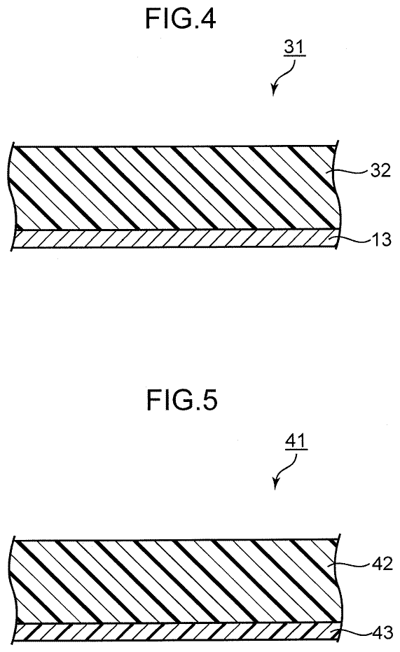

As illustrated in FIG. 4, a metal foil with resin 31 of the present embodiment has a configuration in which a resin layer 32 containing the resin composition described above or a semi-cured product of the resin composition; and a metal foil 13 are laminated. In other words, the metal foil with resin of the present embodiment may be a metal foil with resin including a resin layer containing the resin composition before curing (the resin composition in A stage) and a metal foil, or may be a metal foil with resin including a resin layer containing a semi-cured product of the resin composition (the resin composition in B stage) and a metal foil.

Examples of the method for fabricating such a metal foil with resin 31 include a method in which a resin composition in the form of a resin varnish as described above is applied to the surface of the metal foil 13 such as a copper foil and then dried. Examples of the application method include a bar coater, a comma coater, a die coater, a roll coater, and a gravure coater.

As the metal foil 13, metal foils to be used in metal-clad laminates, wiring boards and the like can be used without limitation, and examples thereof include copper foil and aluminum foil.

As illustrated in FIG. 5, a film with resin 41 of the present embodiment has a configuration in which a resin layer 42 containing the resin composition described above or a semi-cured product of the resin composition; and a film supporting base material 43 are laminated. In other words, the film with resin of the present embodiment may be a film with resin including the resin composition before curing (the resin composition in A stage); and a film supporting base material, or a film with resin including a semi-cured product of the resin composition (the resin composition in B stage); and a film supporting base material.

As the method for fabricating such a film with resin 41, for example, a resin composition in the form of a resin varnish as described above is applied to the surface of the film supporting base material 43, and then the solvent is volatilized from the varnish and diminished or removed, whereby a film with resin before curing (A stage) or in a semi-cured state (B stage) can be obtained.

Examples of the film supporting base material include electrical insulating films such as a polyimide film, a PET (polyethylene terephthalate) film, a polyethylene naphthalate film, a polyester film, a poly(parabanic acid) film, a polyether ether ketone film, a polyphenylene sulfide film, an aramid film, a polycarbonate film, and a polyarylate film.

In the film with resin and the metal foil with resin of the present embodiment as well, the resin composition or a semi-cured product thereof may be one obtained by drying or heating and drying the resin composition as in the prepreg described above.

The thickness and the like of the metal foil 13 and the film supporting base material 43 can be appropriately set depending on the desired purpose. For example, as the metal foil 13, a metal foil having a thickness of about 0.2 to about 70 μm can be used. In a case where the thickness of metal foil is, for example, 10 μm or less, the metal foil may be a carrier-attached copper foil including a release layer and a carrier in order to improve handleability. The application of the resin varnish to the metal foil 13 and the film supporting base material 43 is performed by application or the like, and this can be repeated multiple times, as necessary. At this time, it is also possible to repeat the application using a plurality of resin varnishes having different compositions or concentrations, and adjust the composition (content ratio) and resin amount to the finally desired values.

Drying or heating and drying conditions in the fabrication method of the metal foil with resin 31 and film with resin 41 are not particularly limited, but a resin composition in the form of a resin varnish is applied to the metal foil 13 and film supporting base material 43, and then heating is performed under desired heating conditions, for example, at 50° C. to 180° C. for about 0.1 to about 10 minutes to volatilize the solvent from the varnish and diminish or remove the solvent, whereby the metal foil with resin 31 and film with resin 41 before curing (A stage) or in a semi-cured state (B stage) are obtained.

The metal foil with resin 31 and film with resin 41 may include a cover film and the like, as necessary. Since the cover film is included, it is possible to prevent foreign matter from entering. The cover film is not particularly limited as long as it can be peeled off without damaging the form of the resin composition, and for example, a polyolefin film, a polyester film, a TPX film, films formed by providing a release agent layer on these films, and paper obtained by laminating these films on a paper base material can be used.

As illustrated in FIG. 2, a metal-clad laminate 11 of the present embodiment includes an insulating layer 12 containing a cured product of the resin composition described above or a cured product of the prepreg described above; and a metal foil 13. As the metal foil 13 to be used in the metal-clad laminate 11, a metal foil similar to the metal foil 13 described above can be used.

The metal-clad laminate 11 of the present embodiment can also be fabricated using the metal foil with resin 31 or the film with resin 41 described above.

As the method for fabricating a metal-clad laminate using the prepreg 1, metal foil with resin 31, or film with resin 41 obtained in the manner described above, one or a plurality of prepregs 1, metal foils with resin 31, or films with resin 41 are superimposed on one another, and the metal foils 13 such as copper foil are further superimposed on both upper and lower sides or on one side, and this is laminated and integrated by heating and pressing, whereby a double-sided metal-clad or single-sided metal-clad laminate can be fabricated. The heating and pressing conditions can be appropriately set depending on the thickness of the laminate to be fabricated, the kind of the resin composition, and the like, but for example, the temperature may be set to 170° C. to 230° C., the pressure may be set to 1.5 to 5.0 MPa, and the time may be set to 60 to 150 minutes.

The metal-clad laminate 11 may be fabricated by forming a film-like resin composition on the metal foil 13 without using the prepreg 1 or the like and performing heating and pressing.

As illustrated in FIG. 3, a wiring board 21 of the present embodiment includes wiring 14 and an insulating layer 12 containing a cured product of the resin composition described above or a cured product of the prepreg described above.

The resin composition of the present embodiment is suitably used as a material for an insulating layer of a wiring board. As the method for fabricating the wiring board 21, for example, the metal foil 13 on the surface of the metal-clad laminate 11 obtained above is etched to form a circuit (wiring), whereby the wiring board 21 having a conductor pattern (wiring 14) provided as a circuit on the surface of a laminate can be obtained. Examples of the circuit forming method include circuit formation by a semi additive process (SAP) or a modified semi additive process (MSAP) in addition to the method described above.

A prepreg, a film with resin, and a metal foil with resin obtained using the resin composition of the present embodiment are extremely useful in industrial applications since the cured products thereof have superior low dielectric properties, high Tg, and adhesion (particularly, copper foil peel strength). In addition, a metal-clad laminate and a wiring board obtained by curing them also have similar superior properties.

The present specification discloses techniques in various aspects as described above, and the main techniques among these are summarized below.

A resin composition according to a first aspect of the present invention is characterized by including a polyphenylene ether compound (A) having a carbon-carbon unsaturated double bond in a molecule; a polyfunctional vinyl aromatic copolymer (B) containing a repeating unit (b1) derived from a divinyl aromatic compound and a repeating unit (b2) derived from a monovinyl aromatic compound; and a nitrogen-containing compound (C) having at least one among structural units represented by the formulas (1-1), (1-2), and (1-3).

A resin composition according to a second aspect of the present invention is the resin composition according to the first aspect, wherein the nitrogen-containing compound (C) has at least one among structural units represented by the formulas (2-1), (2-2), and (2-3).

A resin composition according to a third aspect of the present invention is the resin composition according to the first or second aspect, wherein the divalent organic group represented by X in the formulas (2-1) to (2-3) contains a group represented by the formula (3).

A resin composition according to a fourth aspect of the present invention is the resin composition according to any one of the first to third aspects, in which the nitrogen-containing compound (C) has a group Y represented by the formula (a) at a terminal.

A resin composition according to a seventh aspect of the present invention is the resin composition according to any one of the first to sixth aspects, wherein the content of the polyfunctional vinyl aromatic copolymer (B) is 40% by mass or more and 80% by mass or less with respect to the total amount of the polyphenylene ether compound (A), the polyfunctional vinyl aromatic copolymer (B), and the nitrogen-containing compound (C).

A resin composition according to a sixth aspect of the present invention is the resin composition according to any one of the first to fifth aspects, wherein the polyphenylene ether compound (A) is a polyphenylene ether compound having at least one of groups represented by the formula (4) or (5).

A resin composition according to a seventh aspect of the present invention is the resin composition according to any one of the first to sixth aspects, wherein the content of the polyfunctional vinyl aromatic copolymer (B) is 40% by mass or more and 80% by mass or less with respect to the total amount of the polyphenylene ether compound (A), the polyfunctional vinyl aromatic copolymer (B), and the nitrogen-containing compound (C).

A resin composition according to an eighth aspect of the present invention is the resin composition according to any one of the first to seventh aspects, wherein the resin composition further includes an inorganic filler (D) and the content of the inorganic filler (D) is 30 parts by mass or more and 150 parts by mass or less with respect to 100 parts by mass of the sum of the polyphenylene ether compound (A), the polyfunctional vinyl aromatic copolymer (B), and the nitrogen-containing compound (C).

A resin composition according to a ninth aspect of the present invention is the resin composition according to any one of the first to eighth aspects, further including a flame retardant (E).

A prepreg according to a tenth aspect of the present invention includes the resin composition according to any one of the first to ninth aspects or a semi-cured product of the resin composition; and a fibrous base material.

A film with resin according to an eleventh aspect of the present invention includes a resin layer containing the resin composition according to any one of the first to ninth aspects or a semi-cured product of the resin composition; and a support film.

A metal foil with resin according to a twelfth aspect of the present invention includes a resin layer containing the resin composition according to any one of the first to ninth aspects or a semi-cured product of the resin composition, and a metal foil.

A metal-clad laminate according to a thirteenth aspect of the present invention includes an insulating layer containing a cured product of the resin composition according to any one of the first to ninth aspects or a cured product of the prepreg according to the tenth aspect, and a metal foil.

A wiring board according to a fourteenth aspect of the present invention includes an insulating layer containing a cured product of the resin composition according to any one of the first to ninth aspects or a cured product of the prepreg according to the tenth aspect, and a wiring.

Hereinafter, the present invention will be described more specifically with reference to Examples, but the scope of the present invention is not limited to these.

### Examples

First, the components to be used in the preparation of resin compositions in the present Examples will be described.

### <Polyphenylene Ether Compound (A)>

### Synthesis of Modified PPE1:

Modified polyphenylene ether compound 2 was obtained by reacting polyphenylene ether with chloromethylstyrene. Specifically, into a 1 L three-neck flask equipped with a temperature controller, a stirrer, a cooling facility, and a dropping funnel, 200 g of polyphenylene ether (SA90 manufactured by SABIC Innovative Plastics Co., Ltd., intrinsic viscosity (IV): 0.083 dl/g, number of terminal hydroxy groups: 1.9, weight molecular weight Mw: 1700), 30 g of a mixture of p-chloromethylstyrene and m-chloromethylstyrene at a mass ratio of 50:50 (chloromethylstyrene:CMS manufactured by Tokyo Chemical Industry Co., Ltd.), 1.227 g of tetra-n-butylammonium bromide as a phase transfer catalyst, and 400 g of toluene were first put and stirred. Then, the mixture was stirred until polyphenylene ether, chloromethylstyrene, and tetra-n-butylammonium bromide were dissolved in toluene. At that time, the mixture was gradually heated until the liquid temperature finally reached 75° C. Then, an aqueous sodium hydroxide solution (20 g of sodium hydroxide/20 g of water) as an alkali metal hydroxide was added dropwise to the solution over 20 minutes. Thereafter, the mixture was further stirred at 75° C. for 4 hours. Next, the resultant in the flask was neutralized with hydrochloric acid at 10% by mass and then a large amount of methanol was added into the flask. By doing so, a precipitate was generated in the liquid in the flask. In other words, the product contained in the reaction solution in the flask was reprecipitated. Then, this precipitate was taken by filtration and washed three times with a liquid mixture of methanol and water at a mass ratio of 80:20, and then dried at 80° C. under reduced pressure for 3 hours.

The obtained solid was analyzed by ¹H-NMR (400 MHz, CDCl₃, TMS). As a result of NMR measurement, a peak attributed to ethenylbenzyl was confirmed at 5 to 7 ppm. This made it possible to confirm that the obtained solid was polyphenylene ether vinylbenzylated at a molecular terminal (a polyphenylene ether compound having a vinylbenzyl group at a terminal).

The molecular weight distribution of the modified polyphenylene ether was measured by GPC. Then, the weight average molecular weight (Mw) was calculated from the obtained molecular weight distribution, and as a result, Mw was 2,300.

The number of terminal functional groups of the modified polyphenylene ether was measured as follows:

First, the modified polyphenylene ether was accurately weighed. The weight at that time is denoted by X (mg). Thereafter, this modified polyphenylene ether weighed was dissolved in 25 mL of methylene chloride, and to this solution was added 100 μL of an ethanol solution of tetraethylammonium hydroxide (TEAH) at 10% by mass (TEAH:ethanol (volume ratio)=15:85). Then, the absorbance (Abs) of this mixture at 318 nm was measured using a UV spectrophotometer (UV-1600 manufactured by Shimadzu Corporation). Then, the number of terminal hydroxy groups in the modified polyphenylene ether was calculated from the measurement results using the following equation.

$$Residual O H amount ( μ mol / g ) = [ ( 25 \times Abs ) / ( ε \times O P L \times X ) ] \times 1 {0}^{6}$$

Here, ε denotes the extinction coefficient an is 4700 L/mol·cm. OPL denotes the cell optical path length and is 1 cm.

Since the calculated residual OH amount (the number of terminal hydroxy groups) in the modified polyphenylene ether is almost zero, it was found that the hydroxy groups in the polyphenylene ether before being modified are almost modified. From this fact, it was found that the number of terminal hydroxy groups decreased from the number of terminal hydroxy groups in polyphenylene ether before being modified was the number of terminal hydroxy groups in polyphenylene ether before being modified. In other words, it was found that the number of terminal hydroxy groups in the polyphenylene ether before modification is the number of terminal functional groups in the modified polyphenylene ether. That is, the number of terminal functional groups was 1.8. This is named “polyphenylene ether compound 2”. The average number of phenolic hydroxy groups at the terminals of the molecule per one molecule of polyphenylene ether is here denoted as the number of terminal hydroxy groups.

### Modified PPE 2:

Modified polyphenylene ether compound having a methacryloyl group at a terminal (“SA 9000” manufactured by SABIC Innovative Plastics, modified polyphenylene ether obtained by modifying terminal hydroxy group of polyphenylene ether with methacryloyl group, weight average molecular weight Mw: 2000)

### <Polyfunctional Vinyl Aromatic Polymer (B)>

A polyfunctional vinyl aromatic polymer was obtained based on the following method:

Into a 5.0 L reactor, 3.0 mol (390.6 g) of divinylbenzene, 1.8 mol (229.4 g) of ethylvinylbenzene, 10.2 mol (1066.3 g) of styrene and 15.0 mol (1532.0 g) of n-propyl acetate were charged, 600 mmol of boron trifluoride diethyl ether complex was added at 70° C., and the reaction was conducted for 4 hours. After the polymerization solution was terminated with an aqueous sodium bicarbonate solution, the oil layer was washed three times with pure water and volatilized under reduced pressure at 60° C., and the copolymer was collected. The obtained copolymer was weighed to find that 896.7 g of copolymer B was obtained.

The obtained copolymer B had an Mn of 2980, an Mw of 41300, and an Mw/Mn of 13.9. The obtained copolymer A was subjected to ¹³C-NMR and ¹H-NMR analysis, and as a result, resonance lines derived from each monomer unit were observed. Based on the NMR measurement results and the GC analysis results, the structural units of the copolymer A were calculated as follows. The structural units of the copolymer B were calculated as follows.

Structural unit derived from divinylbenzene (b1): 30.4 mol % (33.1 wt %)

Structural unit derived from ethylvinylbenzene (b2-2): 12.2 mol % (14.2 wt %)

Structural unit derived from styrene (b2-1): 57.4 mol % (52.7 wt %)

Structural unit having residual vinyl group derived from divinylbenzene (b1-1): 23.9 mol % (25.9 wt %)

### <Nitrogen-Containing Compound (C)>

Nitrogen-containing compound: “HC-G 0037” (manufactured by JSR Corporation)

### <Flame Retardant (E)>

Flame retardant 1: Bromine-based flame retardant (“SAYTEX 8010” manufactured by Albemarle Japan Corporation)
Flame retardant 2: Phosphorus-based flame retardant, “PQ60” (manufactured by Chin Yee Chemical Industries Co., Ltd.)

### <Free Radical Compound>

Free radical compound: ADK STAB “LA-7RD” (manufactured by ADEKA Corporation)

### <Reaction Initiator>

Azo compound: 2,2′-Azobis(2,4,4-trimethylpentane) “VR-110” (manufactured by FUJIFILM Wako Pure Chemical Corporation)

### <Inorganic Filler (D)>

Silica filler: Spherical silica “EQ2410-SMC” (manufactured by Zhejiang Third Age Material Technology Co., Ltd.)

### Examples 1 to 6 and Comparative Examples 1 to 3

### Preparation Method

### (Resin Varnish)

First, the respective components were added to and mixed in toluene solvent at the blending proportions (parts by mass) presented in Table 1 such that the solid concentration of the resin component was 65% by mass. The resulting mixture was stirred for 120 minutes. Thereafter, an inorganic filler (silica filler) was added to the obtained mixture and dispersed in advance using a stirrer, and then the filler was dispersed using a bead mill. By doing so, a varnish-like resin composition (varnish) was obtained.

### (Fabrication of Evaluation Substrate)

A prepreg and an evaluation substrate (metal-clad laminate) were obtained as follows.

First, the obtained varnish was impregnated into a fibrous base material (glass cloth: #1078 type, L2 Glass manufactured by Asahi Kasei Corporation) and then heated and dried at 120° C. for 3 minutes, thereby fabricating a prepreg having a thickness of 100 μm. At that time, the content (resin content) of the components constituting the resin composition with respect to the prepreg was adjusted to be about 74% by mass by the curing reaction.

Next, an evaluation substrate (metal-clad laminate) was obtained as follows.

Four sheets of each of the obtained prepregs were stacked, and copper foil (“CF-T4X-SV-18” manufactured by FUKUDA METAL FOIL & POWDER CO., LTD., copper foil thickness: 18 μm) was disposed on both sides of the stacked body. This as a body to be pressed was heated to a temperature of 200° C. at a rate of temperature rise of 3° C./min and heated and pressed under the conditions of 200° C., 120 minutes, and a pressure of 3 MPa, thereby affording an evaluation substrate (metal-clad laminate) having copper foil bonded to both surfaces and having a resin layer thickness of about 400 μm.

The evaluation substrates (metal-clad laminates) fabricated as described above were used to conduct evaluation tests by the following methods.

### <Evaluation Test 1>

The evaluation substrates of Examples and Comparative Examples were subjected to the following tests.

(Dielectric Properties: Dielectric Loss Tangent (Df)) The dielectric loss tangent (Df) at 10 GHz was measured by a cavity perturbation method using an unclad plate obtained by removing the copper foil from the evaluation substrate (metal-clad laminate) having a thickness of 400 μm by etching as a test piece. Specifically, the dielectric loss tangent of the evaluation substrate at 10 GHz was measured using a network analyzer (N5230A manufactured by Keysight Technologies). In the present test, it is determined as acceptable when the Df is 0.00150 or less.

### (Glass Transition Temperature (Tg))

Tg was measured for a sample obtained by etching the entire surface of the outer layer copper foil of the evaluation substrate (metal-clad laminate) using a viscoelastic spectrometer “DMA7100” manufactured by Hitachi High-Tech Science Corporation. At this time, dynamic viscoelasticity measurement (DMA) was performed in a tensile module at a frequency of 1 Hz, and the temperature at which tan δ was locally maximized when the temperature was raised from room temperature to 300° C. at a rate of temperature rise of 5° C./min was taken as Tg.

In the present test, it is determined as acceptable when the Tg is 150° C. or more.

The results are presented in Table 1.

TABLE 1

| | | | | | | | | Compar- | Compar- | Compar- | Compar- |
|---|---|---|---|---|---|---|---|---|---|---|---|
| | | Exam- | Exam- | Exam- | Exam- | Exam- | Exam- | ative | ative | ative | ative |
| | | ple 1 | ple 2 | ple 3 | ple 4 | ple 5 | ple 6 | Example 1 | Example 2 | Example 3 | Example 4 |
| Compo- | Polyfunctional vinyl | 50 | 50 | 60 | 70 | 50 | 50 | 50 | 50 | 0 | 70 |
| sition | aromatic copolymer | | | | | | | | | | |
| parts by | Nitrogen-containing | 25 | 25 | 20 | 15 | 25 | 25 | 50 | — | 50 | 30 |
| mass | compound | | | | | | | | | | |
| | Modified PPE 1 | 25 | 0 | 20 | 15 | 25 | 25 | 0 | 50 | 50 | 0 |
| | Modified PPE 2 | 0 | 25 | 0 | 0 | — | — | 0 | 0 | 0 | 0 |
| | Free radical | 0.1 | 0.1 | 0.1 | 0.1 | 0.1 | 0.1 | 0.1 | 0.1 | 0.1 | 0.1 |
| | compound | | | | | | | | | | |
| | Reaction initiator | 0.5 | 0.5 | 0.5 | 0.5 | 0.5 | 0.5 | 0.5 | 0.5 | 0.5 | 0.5 |
| | Flame retardant 1 | 20 | 20 | 20 | 20 | — | 20 | 20 | 20 | 20 | 20 |
| | Flame retardant 2 | — | — | — | — | 20 | — | — | — | — | — |
| | Inorganic filler | 40 | 40 | 40 | 40 | 40 | 120 | 40 | 40 | 40 | 40 |
| Evalu- | Df @10 GHz | 0.00143 | 0.00110 | 0.00134 | 0.00110 | 0.0013 | 0.0011 | 0.00116 | 0.00164 | 0.00199 | 0.00102 |
| ation | Tg (1 Hz) | 155.4 | 154.9 | 160.7 | 159.2 | 173.9 | 171.1 | 136.6 | 173.4 | 146.8 | 146.7 |
| result | | | | | | | | | | | |

### (Discussion)

As is clear from the results presented in Table 1, it was confirmed that a cured product having low dielectric properties (Df) and a high Tg is obtained from the resin composition of the present invention. On the other hand, in the resin compositions of Comparative Examples 1 and 4 containing no polyphenylene ether compound (A), a sufficiently high Tg could not be obtained. In Comparative Example 2 in which a resin composition containing no nitrogen-containing compound (C) was used, the low dielectric properties were insufficient. In Comparative Example 3 in which a resin composition containing no polyfunctional vinyl aromatic copolymer (B) was used, both the low dielectric properties and the Tg were insufficient.

### <Evaluation Test 2>

The evaluation substrates of Examples were further subjected to the following tests.

### (Dielectric Properties: Relative Dielectric Constant (Dk))

The relative dielectric constant (Dk) at 10 GHz was measured by a cavity perturbation method using an unclad plate obtained by removing the copper foil from the evaluation substrate (metal-clad laminate) having a thickness of 400 μm by etching as a test piece. Specifically, the dielectric loss tangent of the evaluation substrate at 10 GHz was measured using a network analyzer (N5230A manufactured by Keysight Technologies). In the present test, it is determined as “good” when the Dk is 3.3 or less.

### (Copper Foil Peel Strength)

The copper foil was peeled off from the evaluation substrate (metal-clad laminate), and the peel strength at that time was measured in conformity with JIS C 6481 (1996). Specifically, the evaluation substrate was cut to have a width of 10 mm and a length of 100 mm, the copper foil was peeled off at a speed of 50 mm/min using a tensile tester, and the peel strength (N/mm) at that time was measured. This peel strength is copper foil peel strength, and it was found that adhesion to the metal foil (copper foil) was higher as the peel strength was higher. In the present test, when the copper foil peel strength obtained by measurement was 0.40 N/mm or more, it was determined as “good”.

The results are presented in Table 2.

TABLE 2

| | | Example | Example | Example | Example | Example | Example |
|---|---|---|---|---|---|---|---|
| | | 1 | 2 | 3 | 4 | 5 | 6 |
| Composition | Polyfunctional vinyl aromatic | 50 | 50 | 60 | 70 | 50 | 50 |
| parts by | copolymer | | | | | | |
| mass | Nitrogen-containing | 25 | 25 | 20 | 15 | 25 | 25 |
| | compound | | | | | | |
| | Modified PPE 1 | 25 | 0 | 20 | 15 | 25 | 25 |
| | Modified PPE 2 | 0 | 25 | 0 | 0 | — | — |
| | Free radical compound | 0.1 | 0.1 | 0.1 | 0.1 | 0.1 | 0.1 |
| | Reaction initiator | 0.5 | 0.5 | 0.5 | 0.5 | 0.5 | 0.5 |
| | Flame retardant 1 | 20 | 20 | 20 | 20 | — | 20 |
| | Flame retardant 2 | — | — | — | — | 20 | — |
| | Inorganic filler | 40 | 40 | 40 | 40 | 40 | 120 |
| Evaluation | Dk @10 GHz | 2.95 | 2.63 | 2.89 | 2.85 | 2.92 | 3.05 |
| result | Copper foil peel strength | 0.51 | 0.50 | 0.47 | 0.42 | 0.60 | 0.55 |
| | (adhesion) | | | | | | |

### (Discussion)

As is clear from the results presented in Table 2, it was confirmed that the resin composition of the present invention affords a cured product having low Dk and superior adhesion (peel strength).

This application is based on Japanese Patent application No. 2024-21213 filed in Japan Patent Office on Dec. 10, 2024, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A resin composition comprising:
a polyphenylene ether compound (A) having a carbon-carbon unsaturated double bond in a molecule;
a polyfunctional vinyl aromatic copolymer (B) containing a repeating unit (b1) derived from a divinyl aromatic compound and a repeating unit (b2) derived from a monovinyl aromatic compound; and
a nitrogen-containing compound (C) having at least one among structural units represented by the following formulas (1-1), (1-2), and (1-3): 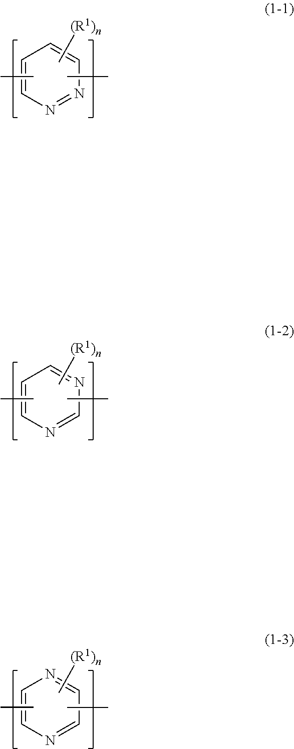
in the formulas (1-1) to (1-3), R¹ is independently at each occurrence a halogen atom, a monovalent hydrocarbon group having 1 to 20 carbon atoms, a monovalent halogenated hydrocarbon group having 1 to 20 carbon atoms, a nitro group, a cyano group, a primary to tertiary amino group, or a salt of a primary to tertiary amino group; n is independently at each occurrence an integer of 0 to 2; when n is 2, a plurality of R¹s may be the same or different and may be bonded in any combination to form a part of a ring structure.

2. The resin composition according to claim 1, wherein
the nitrogen-containing compound (C) has at least one among structural units represented by the following formulas (2-1), (2-2), and (2-3): 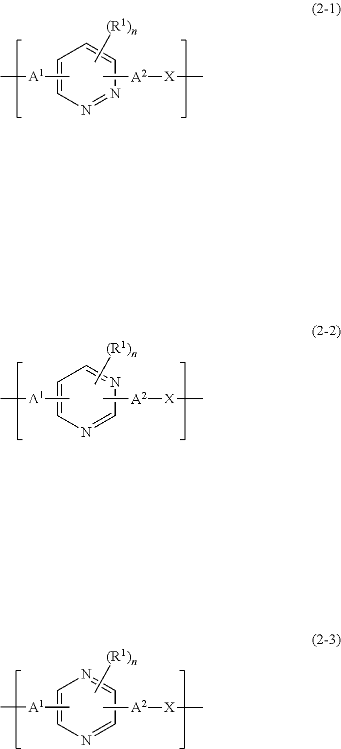
in the formulas (2-1) to (2-3), R¹ and n are the same as R¹ and n in the formulas (1-1) to (1-3); A¹ and A² are each independently —O—, —S—, or —N(R²)—; R² is a hydrogen atom, a monovalent hydrocarbon group having 1 to 20 carbon atoms, or a monovalent halogenated hydrocarbon group having 1 to 20 carbon atoms; X is a divalent organic group.

3. The resin composition according to claim 2, wherein
the divalent organic group represented by X in the formulas (2-1) to (2-3) contains a group represented by the following formula (3): 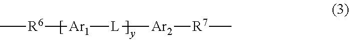
in the formula (3), Ar₁ and Ar₂ are each independently a substituted or unsubstituted aromatic hydrocarbon group; L is a single bond, —O—, —S—, —N(R⁸), C═O, —SO₂—, P═O, or a divalent organic group; R⁸ is a hydrogen atom, a monovalent hydrocarbon group having 1 to 20 carbon atoms, or a monovalent halogenated hydrocarbon group having 1 to 20 carbon atoms; y is an integer of 0 to 5; when y is 2 or more, a plurality of L's may be the same or different; R⁶ and R⁷ are each independently a single bond, a methylene group, or an alkylene group having 2 to 4 carbon atoms.

4. The resin composition according to claim 1, wherein
the nitrogen-containing compound (C) has a group Y represented by the following formula (a) at a terminal: 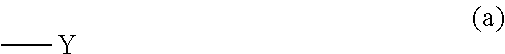
in the formula (a), Y is a group having 3 to 50 carbon atoms and containing an ethylenically unsaturated double bond, an unsubstituted or substituted aromatic hydrocarbon group having 6 to 50 carbon atoms, an unsubstituted or substituted aliphatic hydrocarbon group having 6 to 50 carbon atoms, or an unsubstituted nitrogen-containing heteroaromatic ring; when the aromatic hydrocarbon group or the aliphatic hydrocarbon group has a substituent, the substituent is a group other than a hydroxy group.

5. The resin composition according to claim 1, wherein a content of the nitrogen-containing compound (C) is 5% by mass or more and 50% by mass or less with respect to a total amount of the polyphenylene ether compound (A), the polyfunctional vinyl aromatic copolymer (B), and the nitrogen-containing compound (C).

6. The resin composition according to claim 1, wherein
the polyphenylene ether compound (A) is a polyphenylene ether compound having at least one of groups represented by the following formula (4) or formula (5): 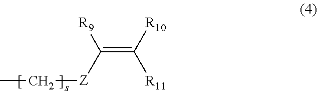
in the formula (4), s represents an integer of 0 to 10; Z represents an arylene group; R₉ to R₁₁ each independently represent a hydrogen atom or an alkyl group, and 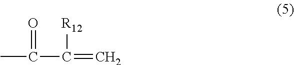
in the formula (5), R₁₂ represents a hydrogen atom or an alkyl group.

7. The resin composition according to claim 1, wherein a content of the polyfunctional vinyl aromatic copolymer (B) is 40% by mass to 80% by mass or less with respect to a total amount of the polyphenylene ether compound (A), the polyfunctional vinyl aromatic copolymer (B), and the nitrogen-containing compound (C).

8. The resin composition according to claim 1, further comprising an inorganic filler (D),
wherein a content of the inorganic filler (D) is 30 parts by mass or more and 150 parts by mass or less with respect to 100 parts by mass of a sum of the polyphenylene ether compound (A), the polyfunctional vinyl aromatic copolymer (B), and the nitrogen-containing compound (C).

9. The resin composition according to claim 1, further comprising a flame retardant (E).

10. A prepreg comprising the resin composition according to claim 1 or a semi-cured product of the resin composition, and a fibrous base material.

11. A film with resin comprising a resin layer containing the resin composition according to claim 1 or a semi-cured product of the resin composition, and a support film.

12. A metal foil with resin comprising a resin layer containing the resin composition according to claim 1 or a semi-cured product of the resin composition, and a metal foil.

13. A metal-clad laminate comprising an insulating layer containing a cured product of the resin composition according to claim 1, and a metal foil.

14. A metal-clad laminate comprising an insulating layer containing a cured product of the prepreg according to claim 10, and a metal foil.

15. A wiring board comprising an insulating layer containing a cured product of the resin composition according to claim 1, and a wiring.

16. A wiring board comprising an insulating layer containing a cured product of the prepreg according to claim 10, and a wiring.
